(19) United States
(12) Patent Application Publication
(10) Pub. No.: US 2016/0233987 A1
(43) Pub. Date: Aug. 11, 2016

(54) INITIATOR TERMINAL, TARGET TERMINAL, INITIATOR TERMINAL ERROR-PROCESSING METHOD, AND TARGET TERMINAL ERROR-PROCESSING METHOD

(71) Applicant: PANASONIC INTELLECTUAL PROPERTY MANAGEMENT CO., LTD., Osaka (JP)

(72) Inventors: Nobuhiko ARASHIN, Osaka (JP); Akira YAMASAKI, Osaka (JP)

(21) Appl. No.: 15/022,698

(22) PCT Filed: Oct. 10, 2014
(86) PCT No.: PCT/JP2014/005165

§ 371 Date: Mar. 17, 2016

(30) Foreign Application Priority Data
Oct. 25, 2013 (JP) 2013-221936

(51) Int. Cl. H04L 1/18; H04L 1/06; H04L 29/14

(52) U.S. Cl. CPC H04L 1/1816; H04L 69/40; H04L 1/06; H04W 88/06

(57) ABSTRACT

In a terminal having a plurality of wireless communication methods, an initiator terminal and a target terminal that efficiently execute a recovering process for transmitting data or receiving data if an error occurs are provided. An initiator terminal of the present disclosure includes a first wireless unit configured to connect with a target terminal via wireless communication with a first wireless communication method, a second wireless unit configured to connect with the target terminal via wireless communication with a second wireless communication method different from the first wireless communication method, and an access processor configured to execute an access protocol process for remote access to a storage medium that the target terminal includes. If an error occurs during accessing to the storage medium, the access processor switches the access protocol process for remote access to the storage medium between in the wireless communication in the first wireless unit and in the wireless communication in the second wireless unit.

### TECHNICAL FIELD

The present disclosure relates to a technique for realizing transaction process to access a storage medium that an accessible external terminal includes, similarly to a storage medium that an own terminal includes, by using a plurality of wireless communication methods.

### BACKGROUND ART

Various data, for example, video data is generally transmitted and received by not only wired communication using conventional wired connection but also wireless communication, by improvement of wireless techniques in recent years.

PTL 1 discloses a technique with which serial number information indicating a generating order of a packet is added to each packet, and a packet loss is determined by detecting the serial number information in packets, when video data or the like is transmitted by wireless communication,.

### CITATION LIST

### Patent Literature

PTL 1: International Publication No. 2005/060262

### SUMMARY

An initiator terminal of the present disclosure includes a first wireless unit configured to connect with a target terminal via wireless communication with a first wireless communication method, a second wireless unit configured to connect with the target terminal via wireless communication with a second wireless communication method different from the first wireless communication method, and an access processor configured to execute an access protocol process for remote access to a storage medium that the target terminal includes. If an error occurs during accessing to the storage medium, the access processor switches the access protocol process for remote access to the storage medium between in the wireless communication in the first wireless unit and in the wireless communication in the second wireless unit.

Further, a target terminal of the present disclosure includes a storage medium, a first wireless unit configured to connect with an initiator terminal via wireless communication with a first wireless communication method, a second wireless unit configured to connect with the initiator terminal via wireless communication with a second wireless communication method different from the first wireless communication method, and an access processor configured to permit the initiator terminal to access remotely to a storage medium and to execute an access protocol process for remote access to the storage medium. If an error occurs during accessing to the storage medium from the initiator terminal, the access processor switches the access protocol process for remote access to the storage medium between in the wireless communication in the first wireless unit and in the wireless communication in the second wireless unit.

The present disclosure enables to efficiently execute a retransmitting process for transmitting data and receiving data if an error occurs.

### BRIEF DESCRIPTION OF DRAWINGS

FIG. 1 is a diagram illustrating a configuration of a wireless communication system according to a first exemplary embodiment.

FIG. 2 is a block diagram illustrating a configuration of an initiator terminal and a target terminal according to the first exemplary embodiment.

FIG. 3 is a diagram describing a procedure for obtaining an access control right to a storage medium and a procedure for releasing the access control right, via wireless communication according to the first exemplary embodiment.

FIG. 4 is a diagram illustrating a logical configuration of a wireless packet according to the first exemplary embodiment.

FIG. 5 is a diagram illustrating a logical configuration in a case that encapsulates data of an upper layer in a wireless packet according to the first exemplary embodiment.

FIG. 6 is a diagram describing a format of a Command (CMD) packet for accessing according to the first exemplary embodiment.

FIG. 7 is a diagram describing a format of a command response (CMD Response) packet for accessing according to the first exemplary embodiment.

FIG. 8 is a diagram describing a format of a data (DATA) packet for accessing according to the first exemplary embodiment.

FIG. 9 is a diagram describing a format of an Acknowledgment (ACK) packet for accessing according to the first exemplary embodiment.

FIG. 10 is a diagram describing a format of a Check-Status packet according to the first exemplary embodiment.

FIG. 11 is a diagram describing a format of a Check-Status Response packet according to the first exemplary embodiment.

FIG. 12 is a diagram describing a format of a Clear Bus Handle Request packet according to the first exemplary embodiment.

FIG. 13 is a diagram describing a format of a Clear Bus Handle Response packet according to the first exemplary embodiment.

FIG. 14 is a diagram describing a format of an Interrupt (INT) packet according to the first exemplary embodiment.

FIG. 15 is a diagram describing a sequence where an initiator terminal reads data from a storage medium in a target terminal according to the first exemplary embodiment.

FIG. 16 is a diagram describing a sequence if a data loss occurs during reading data from the storage medium in the target terminal by the initiator terminal according to the first exemplary embodiment.

FIG. 17 is a diagram describing another sequence if a data loss occurs during reading data from the storage medium in the target terminal by the initiator terminal according to the first exemplary embodiment.

FIG. 18 is a diagram describing a sequence where the initiator terminal writes data into the storage medium in the target terminal according to a second exemplary embodiment.

FIG. 19 is a diagram describing a sequence if a data loss occurs during writing data into the storage medium in the target terminal by the initiator terminal.

FIG. 20 is a diagram describing another sequence if a data loss occurs during writing data into the storage medium in the target terminal by the initiator terminal.

### DESCRIPTION OF EMBODIMENTS

Exemplary embodiments are described in detail below suitably with reference to the drawings. Description that is precise beyond necessity is occasionally omitted. For example, detailed description about items already well-known, and overlapped description about substantially the same configurations are occasionally omitted. This is because the following description is prevented from being unnecessarily redundant and is made to be easily understood by a person skilled in the art.

The accompanying drawings and the following description are provided for a person skilled in the art to fully understand the present disclosure, and are not intended to limit the subject matter described in Claims.

### First Exemplary Embodiment

In general, a terminal including a plurality of wireless communication methods as well as one wireless communication method exists. For example, a terminal with wireless Local Area Network (LAN) functions includes two wireless communication methods including a wireless communication method using a frequency band of 2.5 GHz, and a wireless communication method using a frequency band of 5 GHz.

In such terminal, if an error such as a data loss occurs during transmitting data and receiving data, executing the same recovering process regardless of the wireless communication methods might not take advantage of the characteristic of each wireless communication method.

The present disclosure to provide an initiator terminal and a target terminal that include a plurality of wireless communication methods and efficiently execute a recovering process for transmitting data and receiving data if an error occurs.

1-1. Configuration

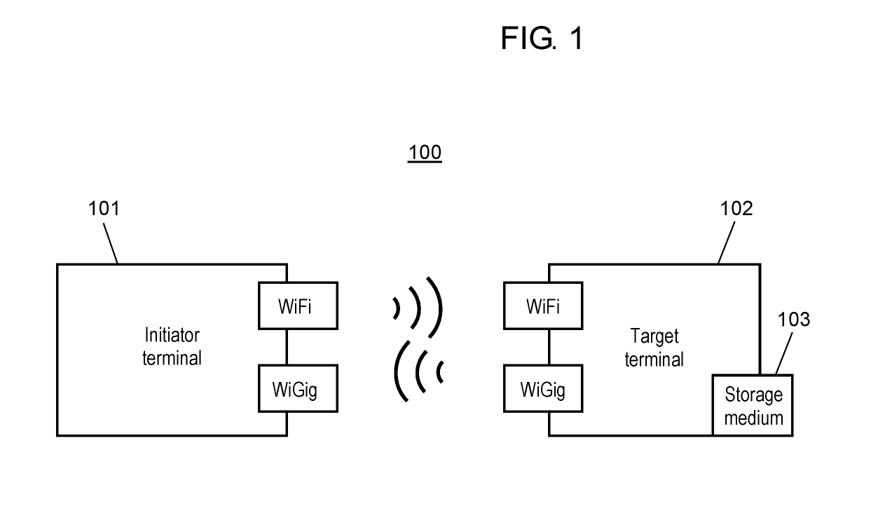

FIG. 1 is a diagram illustrating a configuration of a wireless communication system according to an exemplary embodiment. In FIG. 1, wireless communication system 100 is configured by initiator terminal 101 and target terminal 102. Target terminal 102 includes storage medium 103.

Storage medium 103 includes a storage device for recording data. Storage medium 103 is preferably a non-volatile storage device for holding recorded data even if an electric power that is supplied to storage medium 103 is interrupted. Storage medium 103 may be a bridge medium such as an SD memory card detachable from target terminal 102, or may be a hard disc or a flash memory built in target terminal 102.

Initiator terminal 101 and target terminal 102 are connected communicable with each other by using two wireless communication methods. Initiator terminal 101 establishes wireless communication with target terminal 102 using any one of the two wireless communication methods.

In the exemplary embodiment, for example, Wireless Fidelity (WiFi) is used as a first wireless communication method and Wireless Gigabit (WiGig) is used as a second wireless communication method. A communication speed of WiFi is slower than a communication speed of WiGig.

This exemplary embodiment is not limited to a combination of WiFi and WiGig, and thus any combination of the first wireless communication method and the second wireless communication method may be used as long as the wireless communication methods are different from each other. For example, there are combinations that communication speeds, frequency bands, modulation systems, and wireless protocols are different from each other, during wireless communication.

Further, initiator terminal 101 can access remotely to storage medium 103 that target terminal 102 includes similarly to a storage medium that initiator terminal 101 includes, via the wireless communication. When initiator terminal 101 accesses to storage medium 103, target terminal 102 releases storage medium 103 to initiator terminal 101. Such an access system is called transparent access.

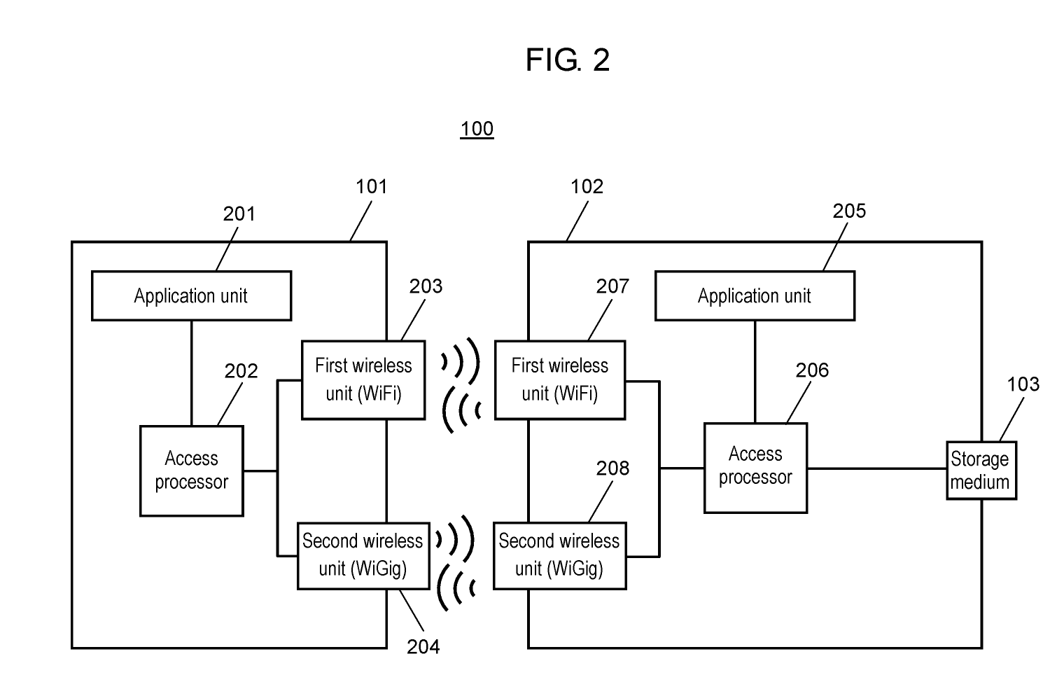

FIG. 2 is a block diagram illustrating a detailed configuration of initiator terminal 101 and target terminal 102. Initiator terminal 101 includes application unit 201, access processor 202, first wireless unit 203, and second wireless unit 204.

Application unit 201 includes a software program or the like for remote access to storage medium 103 in target terminal 102.

Access processor 202 controls whole initiator terminal 101. Further, access processor 202 executes a process as a host that initiator terminal 101 accesses remotely to storage medium 103. Access processor 202 executes a process for transmitting a command with payload of the wireless communication method so as to access to storage medium 103 by using first wireless unit 203 or second wireless unit 204 according to a request from application unit 201, and executes an access protocol process for issuing a command so as to access to storage medium 103 as an initiator. Access processor 202 further mediates an exclusive access right to storage medium 103 between initiator terminal 101 and target terminal 102 and executes also a data process and an error process in the wireless communication.

First wireless unit 203 executes a wireless communication protocol process for communication using the first wireless communication method according to an instruction from access processor 202.

Second wireless unit 204 executes a wireless communication protocol process for communication using the second wireless communication method different from the first wireless communication method according to an instruction from access processor 202.

Target terminal 102 includes application unit 205, access processor 206, first wireless unit 207, and second wireless unit 208.

Application unit 205 includes a software program or the like for access to storage medium 103 in target terminal 102.

Access processor 206 controls whole target terminal 102. Access processor 206 establishes wireless communication with initiator terminal 101 using first wireless unit 207 or second wireless unit 208. Access processor 206 executes a process for writing data into storage medium 103 or reading data from storage medium 103 according to an instruction from initiator terminal 101 or an instruction from application unit 205. Access processor 206 controls application unit 205 and initiator terminal 101 so that accessing exclusively to storage medium 103 realizes, namely, switches a control between a local access and a remote access to storage medium 103. Further, access processor 206 executes an access protocol process for accessing to storage medium 103 as a target.

First wireless unit 207 executes a wireless communication protocol process for establishing the wireless communication with first wireless unit 203 in initiator terminal 101 using the first wireless communication method.

Second wireless unit 208 executes a wireless communication protocol process for establishing the wireless communication with second wireless unit 204 in initiator terminal 101 using the second wireless communication method.

In FIG. 2, as described with reference to FIG. 1, WiFi is used as the first wireless communication method using by first wireless units 203 and 207, and WiGig is used as the second wireless communication method using second wireless units 204 and 208.

1-2. Procedure for Obtaining and Releasing Access Control Right

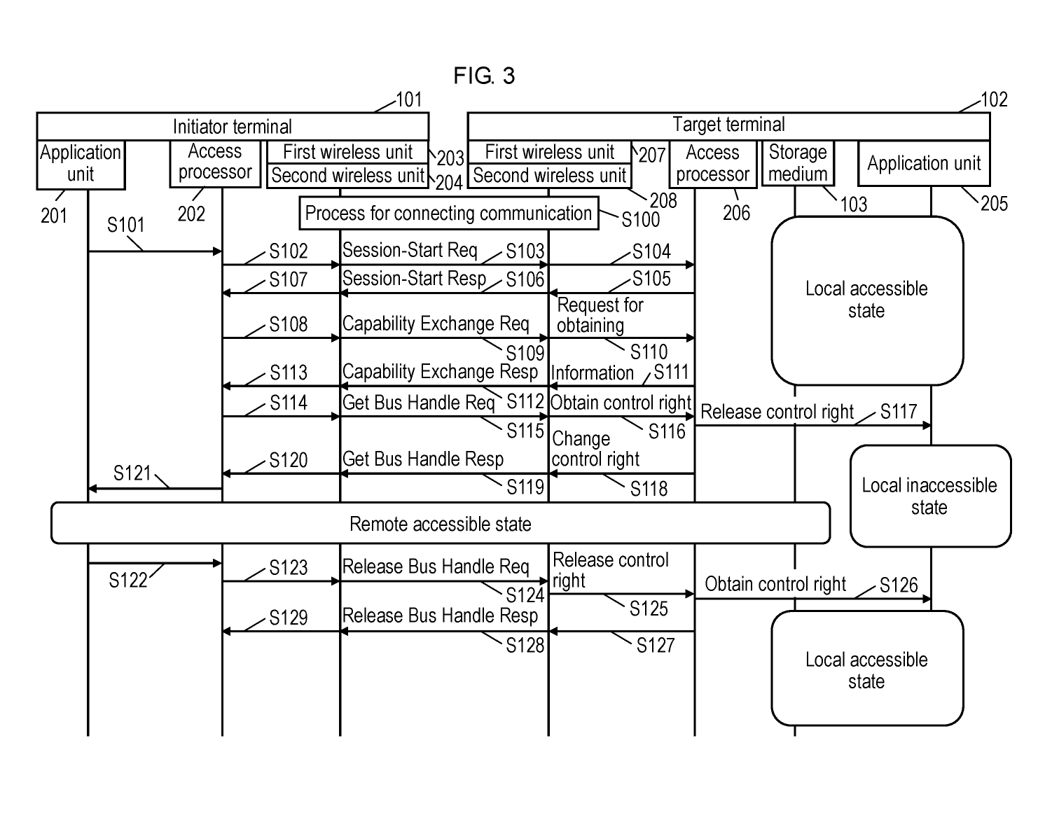

A procedure for obtaining the access control right to storage medium 103 from initiator terminal 101 until accessible, and a procedure for releasing the access control right are described below. FIG. 3 is a diagram describing a procedure for obtaining the access control right to the storage medium and a procedure for releasing the access control right, via wireless communication.

Target terminal 102 can access to storage medium 103 until storage medium 103 is released for initiator terminal 101. That is to say, application unit 205 in target terminal 102 recognizes storage medium 103, and thus target terminal 102 can write data to storage medium 103, read data stored in storage medium 103, and transmit a command to storage medium 103. This state is called a local accessible state.

(Step S100) Initiator terminal 101 and target terminal 102 connect with each other by wireless communication so that initiator terminal 101 accesses to storage medium 103. As a connection for wireless communication, first wireless unit 203 in initiator terminal 101 and first wireless unit 207 in target terminal 102 may establish a wireless communication with the first wireless communication method, or second wireless unit 204 in initiator terminal 101 and second wireless unit 208 in target terminal 102 may establish a wireless communication with the second wireless communication method. As to a choice of the wireless communication method, for example, a wireless communication method with better communication channel information such as large communication channel capacity is selected among the two wireless communication methods. As to this connection for the wireless communication, a procedure does not matter as long as initiator terminal 101 and target terminal 102 establish data communication with the first wireless communication method or the second wireless communication method.

A procedure in which initiator terminal 101 obtains the access control right to storage medium 103 in target terminal 102 is described below.

(Step S101) Application unit 201 in initiator terminal 101 requests processor 202 to access to storage medium 103.

(Step S102) Access processor 202 in initiator terminal 101 controls first wireless unit 203 or second wireless unit 204 based on the established wireless communication method, and instructs target terminal 102 to transmit a wireless packet using an access protocol. That is to say, if the wireless communication is established by the first wireless communication method, access processor 202 transmits a wireless packet to target terminal 102 through first wireless unit 203. If the wireless communication is established by the second wireless communication method, access processor 202 transmits a wireless packet to target terminal 102 through second wireless unit 204.

(Step S103) A wireless packet to be transmitted from first wireless unit 203 or second wireless unit 204 in initiator terminal 101 to first wireless unit 207 or second wireless unit 208 in target terminal 102 is a Session-Start Request packet that initiator terminal 101 instructs storage medium 103 to prepare for a transparent access.

(Step S104) First wireless unit 207 or second wireless unit 208 in target terminal 102 notifies access processor 206 of the received Session-Start Request packet.

(Step S105) Access processor 206 receives an acknowledgment of receiving the Session-Start Request packet from initiator terminal 101. If target terminal 102 can accept the transparent access, target terminal 102 prepares for transferring the access control right of storage medium 103 to initiator terminal 101. An example of this preparation is a process for releasing the access control right to application unit 205 in target terminal 102, if application unit 205 possesses the access control right. Access processor 206 instructs first wireless unit 207 or second wireless unit 208 in target terminal 102 to transmit a response packet upon normally receiving the Session-Start Request packet.

(Step S106) First wireless unit 207 or second wireless unit 208 in target terminal 102 wirelessly transmits a Session-Start Response packet with respect to the Session-Start Request packet to initiator terminal 101 based on an instruction from access processor 206.

(Step S107) Receiving the Session-Start Response packet from first wireless unit 207 or second wireless unit 208 in target terminal 102, first wireless unit 203 or second wireless unit 204 in initiator terminal 101 notifies access processor 202 of receiving the Session-Start Response packet. As a result, a session is established between initiator terminal 101 and target terminal 102.

A procedure in which initiator terminal 101 obtains information about storage medium 103 is described below.

(Step S108) The session is established and access processor 202 requests first wireless unit 203 or second wireless unit 204 in initiator terminal 101 to transmit a wireless packet for obtaining information about storage medium 103.

(Step S109) First wireless unit 203 or second wireless unit 204 in initiator terminal 101 wirelessly transmits a Capability Exchange Request packet to target terminal 102.

(Step S110) Receiving the Capability Exchange Request packet, first wireless unit 207 or second wireless unit 208 in target terminal 102 notifies access processor 206 of receiving the wireless packet for obtaining the information about storage medium 103.

(Step S111) Access processor 206 receives the wireless packet for obtaining the information about storage medium 103 from first wireless unit 207 or second wireless unit 208 in target terminal 102, access processor 206 obtains the information about storage medium 103 including a type of bus interface, a type of device of storage medium 103, a relative address allocated to storage medium 103 such as Relative Card Address (RCA), a status of storage medium 103 such as a write-protect status and a writable status, if storage medium 103 is, for example, an SD memory card. As for types of bus interfaces, there are a standard speed, a high speed, Ultra-High Speed I (UHS-I), and Ultra-High Speed II (UHS-II). As for types of devices of storage medium 103, there are a memory device, an IO device, and a device including two functions both the memory device and the IO device. Access processor 206 instructs first wireless unit 207 or second wireless unit 208 to transmit a wireless packet in response to the Capability Exchange Request.

(Step S112) Receiving an instruction of transmitting the wireless packet in response to the Capability Exchange Request packet from access processor 206, first wireless unit 207 or second wireless unit 208 wirelessly transmits a Capability Exchange Response packet to initiator terminal 101. The Capability Exchange Response packet includes the information about storage medium 103.

(Step S113) Receiving the Capability Exchange Response packet from target terminal 102, first wireless unit 203 or second wireless unit 204 notifies access processor 202 of receiving the information about storage medium 103.

A procedure in which initiator terminal 101 obtains the access control right to storage medium 103 for target terminal 102 is described below.

(Step S114) Receiving the information about storage medium 103, access processor 202 determines whether accessing to storage medium 103 based on the information. For example, if a type of a bus interface to be used in storage medium 103 is not compatible with access processor 202 or application unit 201, access processor 202 determines that it is unable to access to storage medium 103. If the type of the bus interface is compatible, access processor 202 determines that it is able to access to storage medium 103.

Access processor 202 determines based on not limited only the type of the bus interface. Access processor 202 may determine based on other information obtained from storage medium 103.

If access processor 202 determines that it is able to access to storage medium 103, access processor 202 instructs first wireless unit 203 or second wireless unit 204 to transmit a wireless packet for obtaining the access control right.

(Step S115) First wireless unit 203 or second wireless unit 204 transmits a Get Bus Handle Request packet for obtaining the access control right to storage medium 103, to target terminal 102 according to an instruction from access processor 202.

(Step S116) Receiving the Get Bus Handle Request packet from initiator terminal 101, first wireless unit 207 or second wireless unit 208 notifies access processor 206 of receiving the packet for obtaining the access control right to storage medium 103 from initiator terminal 101.

(Step S117) Recognizing for receiving of obtaining the access control right from initiator terminal 101, access processor 206 deletes the access control right to storage medium 103 allocated to application unit 205, from application unit 205. Access processor 206 deletes the access control right allocated to application unit 205 and then application unit 205 cannot access to storage medium 103. Concretely, even if access processor 206 receives a request for accessing to storage medium 103 from application unit 205, access processor 206 cannot accept the request.

The above procedure disables application unit 205 to access to storage medium 103. This state is called a local inaccessible state.

(Step S118) Access processor 206 succeeds in deleting the access control right allocated to application unit 205 and then access processor 206 instructs first wireless unit 207 or second wireless unit 208 to transmit a wireless packet for notifying a change in the control right for transferring the access control right to initiator terminal 101.

(Step S119) First wireless unit 207 or second wireless unit 208 transmits a Get Bus Handle Response packet indicating the change in the access control right as a response to the Get Bus Handle Request packet to initiator terminal 101 according to the instruction from access processor 206.

(Step S120) Receiving the Get Bus Handle Response packet from target terminal 102, first wireless unit 203 or second wireless unit 204 notifies access processor 202 of receiving this packet.

(Step S121) Access processor 202 allocates the access control right to application unit 201. Access processor 202 notifies application unit 201 of enabling to write data into storage medium 103 or to read data from storage medium 103.

If application unit 201 receives an acknowledgment for enabling to access to storage medium 103 from access processor 202, initiator terminal 101 can access to storage medium 103.

By the above procedure, application unit 201 enables to access transparently to storage medium 103 similarly to a storage medium that is connected or inserted to an own terminal via wireless communication. This state is called a remote accessible state.

The above is the procedure for obtaining the access control right.

A procedure for releasing the access control right obtained by initiator terminal 101, and returning the access control right to target terminal 102 is described below.

(Step S122) Application unit 201 does not need to access to storage medium 103 and application unit 201 notifies access processor 202 that accessing to storage medium 103 to access processor 202 is no longer needed.

(Step S123) Access processor 202 deletes the access control right to storage medium 103 allocated to application unit 201. Access processor 202 instructs first wireless unit 203 or second wireless unit 204 to transmit a wireless packet for releasing the access control right to target terminal 102.

(Step S124) Receiving the packet for releasing the access control right from access processor 202, first wireless unit 203 or second wireless unit 204 wirelessly transmits a Release Bus Handle Request packet indicating that the access control right is released for target terminal 102.

(Step S125) Receiving the Release Bus Handle Request packet from initiator terminal 101, first wireless unit 207 or second wireless unit 208 notifies access processor 206 of receiving the packet for releasing the access control right to storage medium 103.

(Step S126) Receiving the an acknowledgement for releasing the access control right from initiator terminal 101, the access processor 206 allocates the access control right to storage medium 103 to application unit 205. Access processor 206 notifies application unit 205 of obtaining the access control right to storage medium 103. As a result, application unit 205 can access to storage medium 103. Application unit 205 is into a local accessible state again.

(Step S127) Access processor 206 instructs first wireless unit 207 or second wireless unit 208 to transmit a wireless packet for notifying initiator terminal 101 of retuning the access control right to storage medium 103 to application unit 205 in target terminal 102.

(Step S128) First wireless unit 207 or second wireless unit 208 wirelessly transmits a Release Bus Handle Response packet indicating that the access control right is returned to target terminal 102, to initiator terminal 101 according to an instruction from access processor 206.

(Step S129) Receiving the Release Bus Handle Response packet from target terminal 102, first wireless unit 203 or second wireless unit 204 notifies access processor 202 of receiving this wireless packet.

The above procedure enables application unit 205 to access to storage medium 103. As a result, application unit 205 returns to be into the local accessible state again.

The above is the procedure for releasing the access control right.

A data format of the wireless packet described in the procedures for obtaining and releasing the access control right is described below.

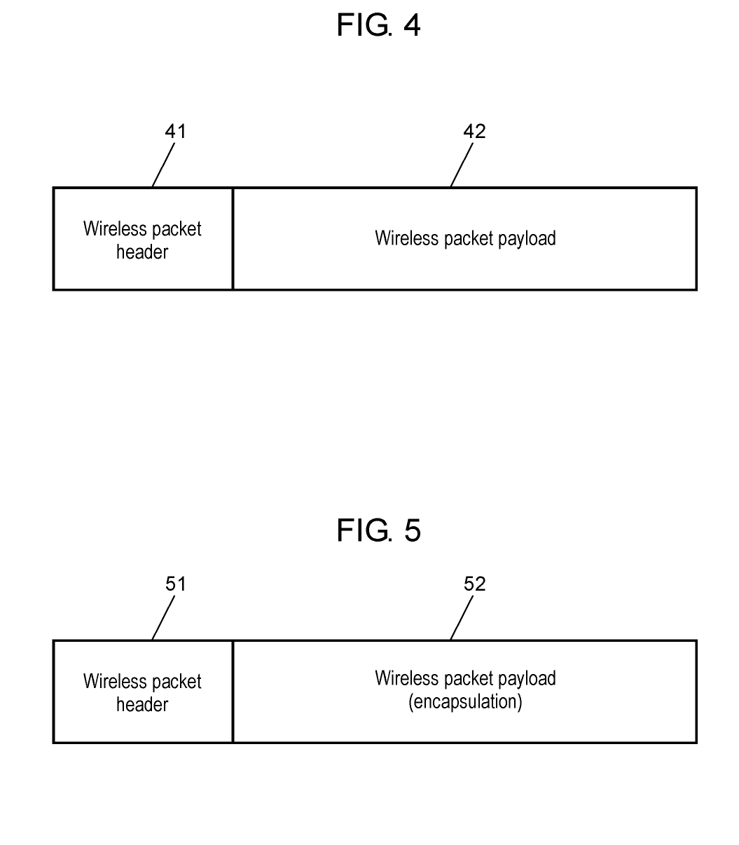

FIG. 4 is a diagram illustrating a logical configuration of the wireless packet. In FIG. 4, the wireless packet includes wireless packet header 41 and wireless packet payload 42.

At the time that first wireless unit 203 and first wireless unit 207 establish wireless communication, or at the time second wireless unit 204 and second wireless unit 208 establish wireless communication, necessary predetermined information is stored in wireless packet header 41. This information includes, for example, identification information for identifying a terminal as a transmission source of a wireless packet, identification information for identifying a terminal as a transmission destination of a wireless packet, and a size of wireless packet payload 42.

Wireless packet payload 42 stores information for transmitting and receiving between initiator terminal 101 and target terminal 102. Wireless packet payload 42 includes identification information for identifying the above-mentioned wireless packets such as a Session-Start Request, a Session-Start Response, a Capability Exchange Request, a Capability Exchange Response, a Get Bus Handle Request, a Get Bus Handle Response, a Release Bus Handle Request, and a Release Bus Handle Response.

As described above, the access control right is managed between initiator terminal 101 and target terminal 102. As a result, initiator terminal 101 and target terminal 102 are prevented from accessing to storage medium 103 at the same time. Only a terminal possessing the access control right can access to storage medium 103, so that a mechanism of an exclusive access to storage medium 103 can be established.

Furthermore, the access control right is transmitted and received between access processor 202 in initiator terminal 101 and access processor 206 in target terminal 102. The access control right is transmitted and received among access processor 202, first wireless unit 203, second wireless unit 204, access processor 206, first wireless unit 207 and second wireless unit 208, that is, among terminals through function blocks on a comparatively lower layer. Application units 201 and 205 on a comparatively upper layer do not directly transmit and receive the access control right. Accessing to storage medium 103 by application units 201 and 205 is managed without awareness of the access control right. This means that access processors 202 and 206 receive a request for accessing to storage medium 103 from application units 201 and 205, and then access processors 202 and 206 control to access to storage medium 103 based on the request and information about existence or non-existence of the access control right. For this reason, application units 201 and 205 do not have to include a function for directly transmitting and receiving the access control right.

Particularly, application unit 201 in initiator terminal 101 can access to storage medium 103 in target terminal 102 as if application unit 201 accesses to a storage medium in a own terminal.

In order that application unit 201 in initiator terminal 101 may access to storage medium 103, it is necessary to devise how to handle data to be transmitted to or received from storage medium 103 along with management for the access control right.

FIG. 5 is a diagram illustrating a logical configuration in a case that encapsulates data of an upper layer in a wireless packet. That is to say, FIG. 5 is a diagram illustrating a logical configuration of a wireless packet to be transmitted and received between first wireless units 203 and 207 or between second wireless units 204 and 208. The wireless packet includes wireless packet header 51 and wireless packet payload 52.

Since wireless packet header 51 is basically the same as wireless packet header 41 described with reference to FIG. 4, description of wireless packet header 51 is omitted.

Wireless packet payload 52 includes specific information transmitted and received between the two terminals. Wireless packet payload 52 stores directly data formats to be used for instruction and notification from application unit 201 to access processor 202, or data formats to be used for instruction and notification from application unit 205 to access processor 206.

Access processor 202, first wireless unit 203, second wireless unit 204, access processor 206, first wireless unit 207 or second wireless unit 208 incorporate directly data formats on the upper layer, for example, application unit 201 and application unit 205 into the payload of the wireless packet. And then data or the like on the upper layer is transmitted by a communication mean on a lower layer. This is called encapsulation.

The wireless packet transmitted and received between first wireless units 203 and 207 or the wireless packet transmitted and received second wireless units 204 and 208 is obtained by packetizing and encapsulating data from application units 201 and 205. The data from application unit 201 is encapsulated into a wireless packet by access processor 202 and first wireless unit 203 or second wireless unit 204 and is transmitted to target terminal 102. Access processor 206 received this wireless packet extracts only a data portion output by application unit 201 in wireless packet payload 52 in the received wireless packet. Access processor 206 outputs the data portion extracted to storage medium 103.

In this way, application unit 201 in initiator terminal 101 enables to transmit data to storage medium 103 in target terminal 102 that is another external terminal, as if storage medium 103 is connected directly to application unit 201.

That is to say, in case where data from an upper layer in a terminal is transmitted and received by using a communication method on a lower layer between two terminals, the data is encapsulated and transmitted to another terminal, and the other terminal received the data extracts the encapsulated data and outputs the extracted data to storage medium 103 on an upper layer. As a result, a transparent access to the storage medium in the other terminal is enabled.

In FIG. 5, wireless packet payload 52 may be composed of only data from the upper layer, or data from the upper layer may be encapsulated into a part of wireless packet payload 52. In this case, wireless packet payload 52 can add additional data besides data from the upper layer.

1-3. Data Formats of Packets for Accessing

Data formats of packets for accessing to be used after initiator terminal 101 is into a remote accessible state to storage medium 103 in target terminal 102 is described below. Since each packet for accessing is a wireless packet, this packet includes a wireless packet header. Further, a wireless packet payload of the wireless packet is encapsulated.

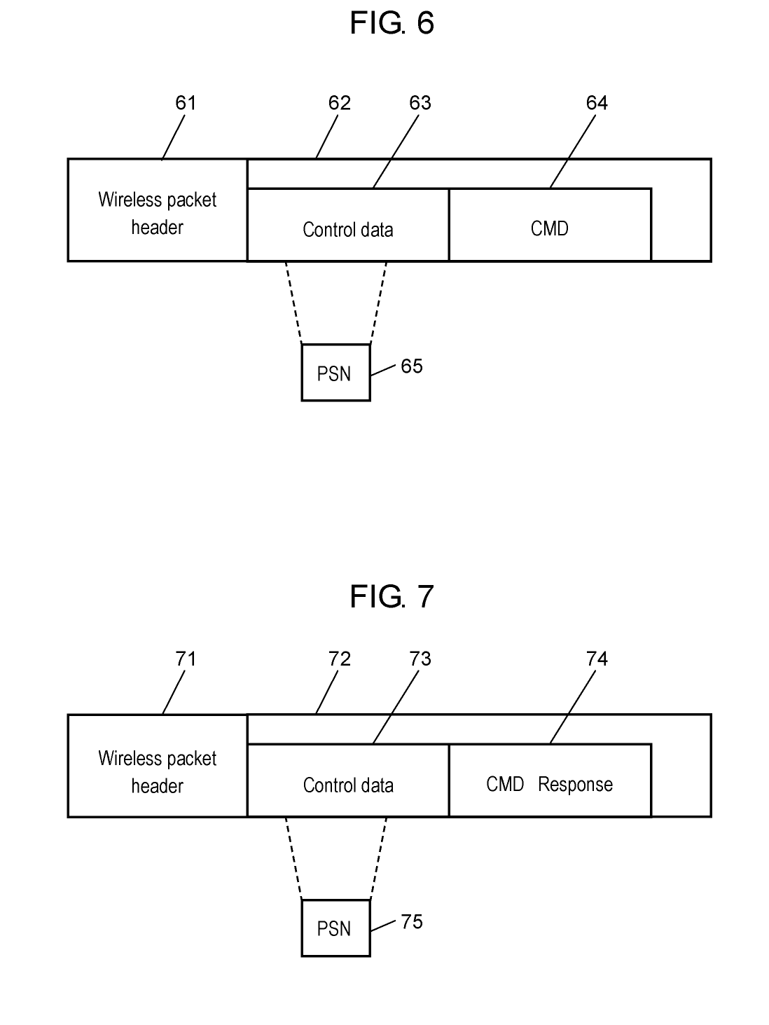

FIG. 6 is a diagram describing a format of a Command (CMD) packet for accessing. The CMD packet includes wireless packet header 61 and wireless packet payload 62. Wireless packet header 61 is similar to wireless packet header 41 in FIG. 4. Wireless packet payload 62 includes control data 63 and CMD 64.

Control data 63 stores predetermined information to be transmitted and received between access processors 202 and 206. Packet Sequence Number (PSN) 65 indicating a sequence number of data packets is stored in control data 63. The PSN starts from 0 and is incremented every time when a data packet is generated.

CMD 64 stores a content of a command for accessing. If initiator terminal 101 accesses to storage medium 103 in target terminal 102 for reading, a Read Command is stored in CMD 64. If initiator terminal 101 accesses to storage medium 103 in target terminal 102 for writing, a Write Command is stored in CMD 64.

FIG. 7 is a diagram describing a format of a Command Response (CMD Response) packet for accessing. The CMD Response packet is used for a response to a CMD packet. The CMD Response packet includes wireless packet header 71 and wireless packet payload 72. Wireless packet header 71 is the same as wireless packet header 41 described with reference to FIG. 4. Wireless packet payload 72 includes control data 73 and CMD Response 74. PSN 75 is stored in control data 73. Control data 73 is the same as control data 63 and PSN 75 is the same as PSN 65, described with reference to FIG. 6. Response content is stored in CMD Response 74.

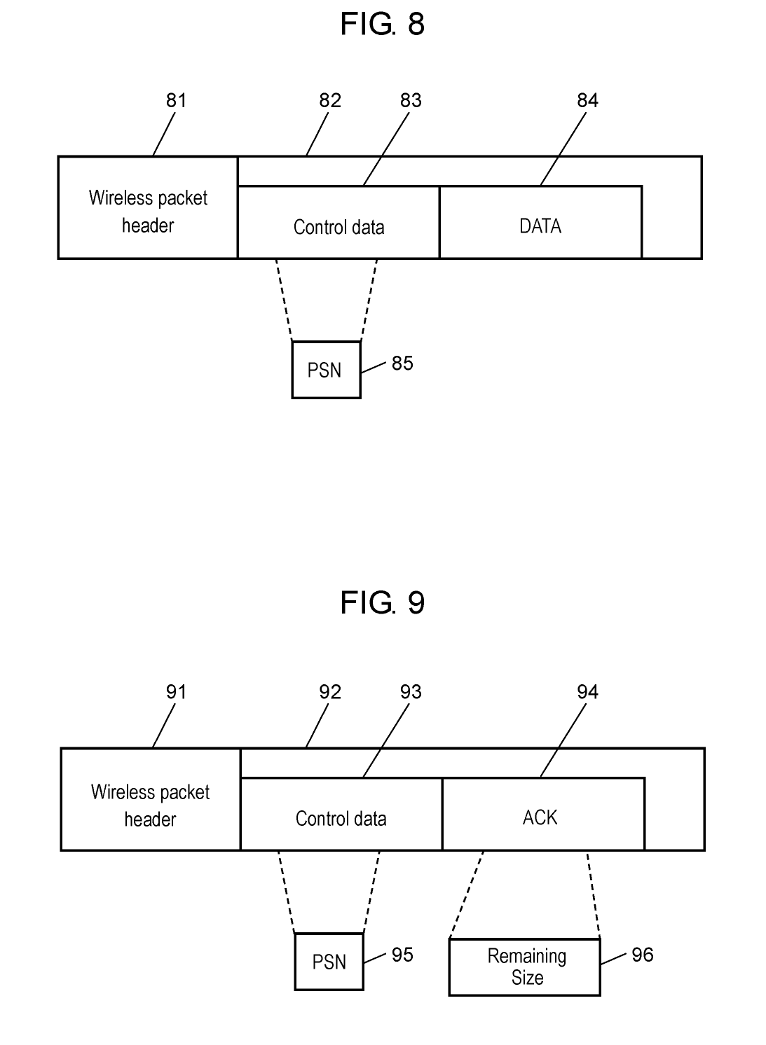

FIG. 8 is a diagram describing a format of a data (DATA) packet for accessing. The DATA packet is used for transmitting data to be transferred between application unit 201 and storage medium 103. The DATA packet includes wireless packet header 81 and wireless packet payload 82. Wireless packet header 81 is the same as wireless packet header 41 described with reference to FIG. 4. Wireless packet payload 82 includes control data 83 and DATA 84. PSN 85 is stored in control data 83. Control data 83 is the same as control data 63 and PSN 85 is the same as PSN 65, described with reference to FIG. 6.

Data to be recorded from application unit 201 to storage medium 103 or data to be read from storage medium 103 to application unit 201 are stored in DATA 84.

FIG. 9 is a diagram describing a format of an Acknowledgment (ACK) packet for accessing. The ACK packet is used for notifying a terminal of a transmission source that the DATA packet reaches. The ACK packet includes wireless packet header 91 and wireless packet payload 92. Wireless packet header 91 is the same as wireless packet header 41 described with reference to FIG. 4. Wireless packet payload 92 includes control data 93 and ACK 94. PSN 95 is stored in control data 93. Control data 93 is the same as control data 63 and PSN 95 is the same as PSN 65, described with reference to FIG. 6.

ACK 94 includes information indicating a response that the DATA packet has been received. ACK 94 includes information of Remaining Size 96 indicating an amount of remaining data to be transmitted. 0 is stored in Remaining Size 96 if the process is completed.

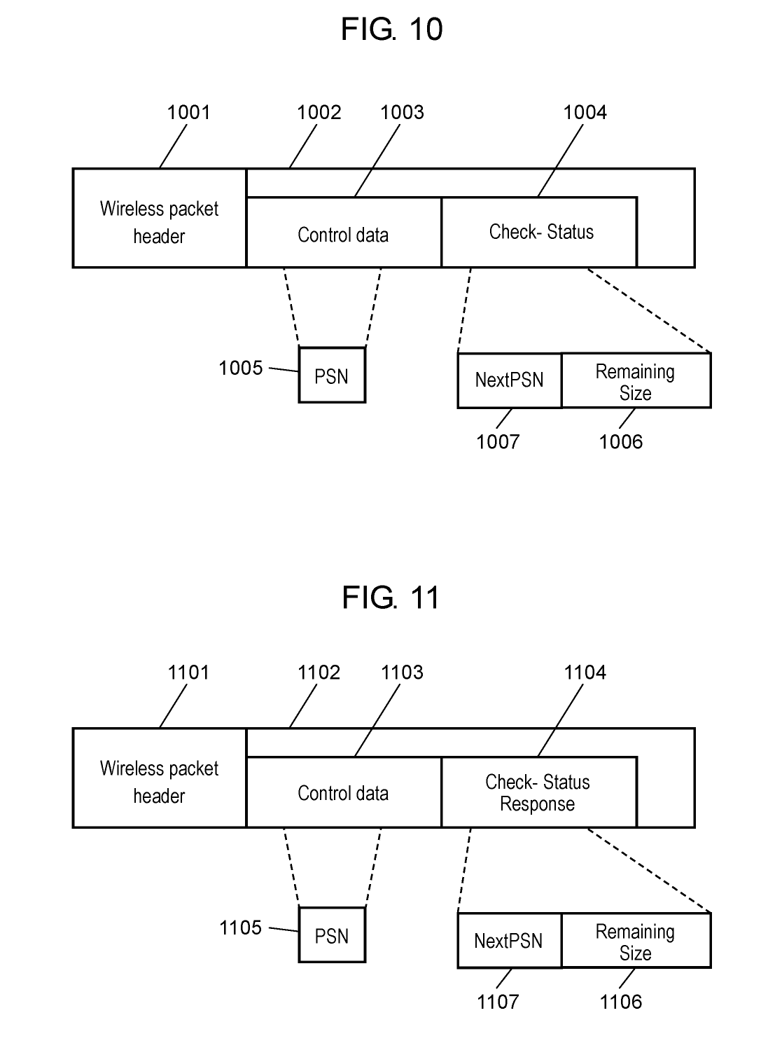

FIG. 10 is a diagram describing a format of a Check-Status packet for accessing. The Check-Status packet is used for notifying a transmission source of a data arrival state. The Check-Status packet includes wireless packet header 1001 and wireless packet payload 1002. Wireless packet header 1001 is the same as wireless packet header 41 described with reference to FIG. 4. Wireless packet payload 1002 includes control data 1003 and Check-Status 1004. PSN 1005 is stored in control data 1003. Control data 1003 is the same as control data 63 and PSN 1005 is the same as PSN 65, described with reference to FIG. 6.

Check-Status 1004 includes Remaining Size 1006 and Next PSN 1007 as information for inquiring a terminal of a transmission source about a state of transmitting and receiving data.

Remaining Size 1006 is the same as Remaining Size 96 described with reference to FIG. 9.

A sequence number of a packet to be expected next is stored in Next PSN 1007.

FIG. 11 is a diagram describing a Check-Status Response packet for accessing. The Check-Status Response packet is used for a response to the Check-Status packet. The Check-Status Response packet includes wireless packet header 1101 and wireless packet payload 1102. Wireless packet header 1101 is the same as wireless packet header 41 described with reference to FIG. 4. Wireless packet payload 1102 includes control data 1103 and Check-Status Response 1104. PSN 1105 is stored in control data 1103. Control data 1103 is the same as control data 63 described with reference to FIG. 6, and PSN 1105 is the same as PSN 65. Check-Status 1104 includes Remaining Size 1106 and Next PSN 1107 as information for a response to a terminal of a transmission destination about a state of transmitting and receiving data.

Remaining Size 1106 is the same as Remaining Size 96 described with reference to FIG. 9.

A sequence number of a packet to be expected next is stored in Next PSN 1107.

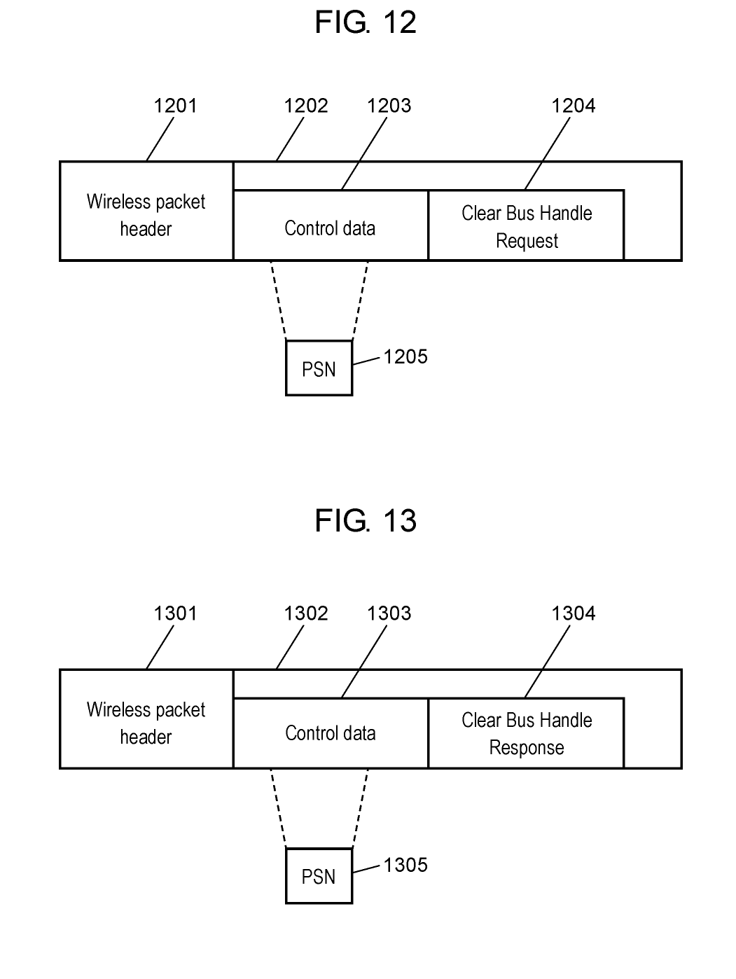

FIG. 12 is a diagram describing a format of a Clear Bus Handle Request packet for accessing. The Clear Bus Handle Request packet is used for interrupting a command process currently executing. The Clear Bus Handle Request packet includes wireless packet header 1201 and wireless packet payload 1202. Wireless packet header 1201 is the same as wireless packet header 41 described with reference to FIG. 4. Wireless packet payload 1202 includes control data 1203 and Clear Bus Handle Request 1204. PSN 1205 is stored in control data 1203. Control data 1203 is the same as control data 63 and PSN 1205 is the same as PSN 65, described with reference to FIG. 6.

FIG. 13 is a diagram describing a format of a Clear Bus Handle Response packet for accessing. The Clear Bus Handle Response packet is used for responding to the Clear Bus Handle Request packet. The Clear Bus Handle Response packet includes wireless packet header 1301 and wireless packet payload 1302. Wireless packet header 1301 is the same as wireless packet header 41 described with reference to FIG. 4. Wireless packet payload 1302 includes control data 1303 and Clear Bus Handle Response 1304. PSN 1305 is stored in control data 1303. Control data 1303 is the same as control data 63 and PSN 1305 is the same as PSN 65, described with reference to FIG. 6.

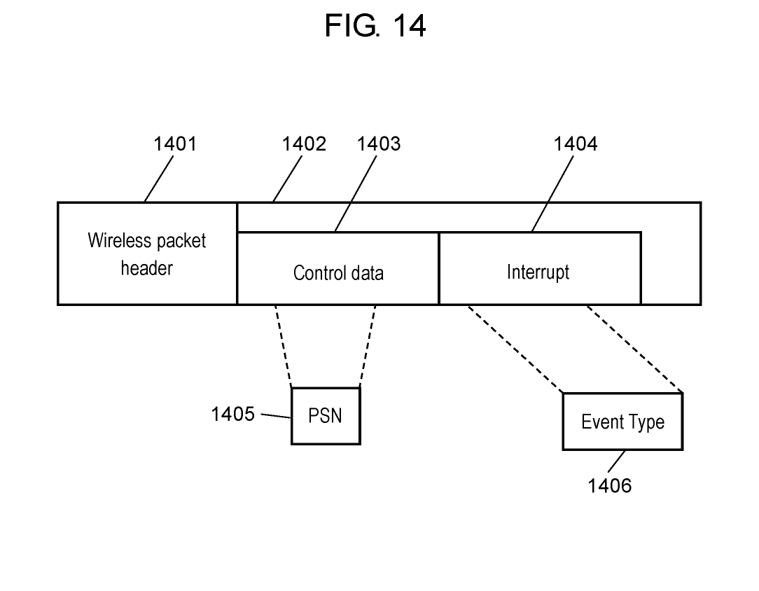

FIG. 14 is a diagram describing a format of an Interrupt (INT) packet for accessing. The INT packet is used for notifying initiator terminal 101 of an interruption of an event from target terminal 102. The INT packet includes wireless packet header 1401 and wireless packet payload 1402. Wireless packet header 1401 is the same as wireless packet header 41 described with reference to FIG. 4. Wireless packet payload 1402 includes control data 1403 and Interrupt 1404. PSN 1405 is stored in control data 1403. Control data 1403 is the same as control data 63 and PSN 1405 is the same as PSN 65, described with reference to FIG. 6.

A content of notifying another terminal of an interruption of an event is stored in Interrupt 1404. Interrupt 1404 includes Event Type1406, and a type of the preset event to be interrupted is stored in Interrupt 1404. For example, in a case of a PSN error caused by a packet loss, a value of an event type corresponding to the PSN error, such as 8, is stored.

1-4. Normal Operation for Reading Data

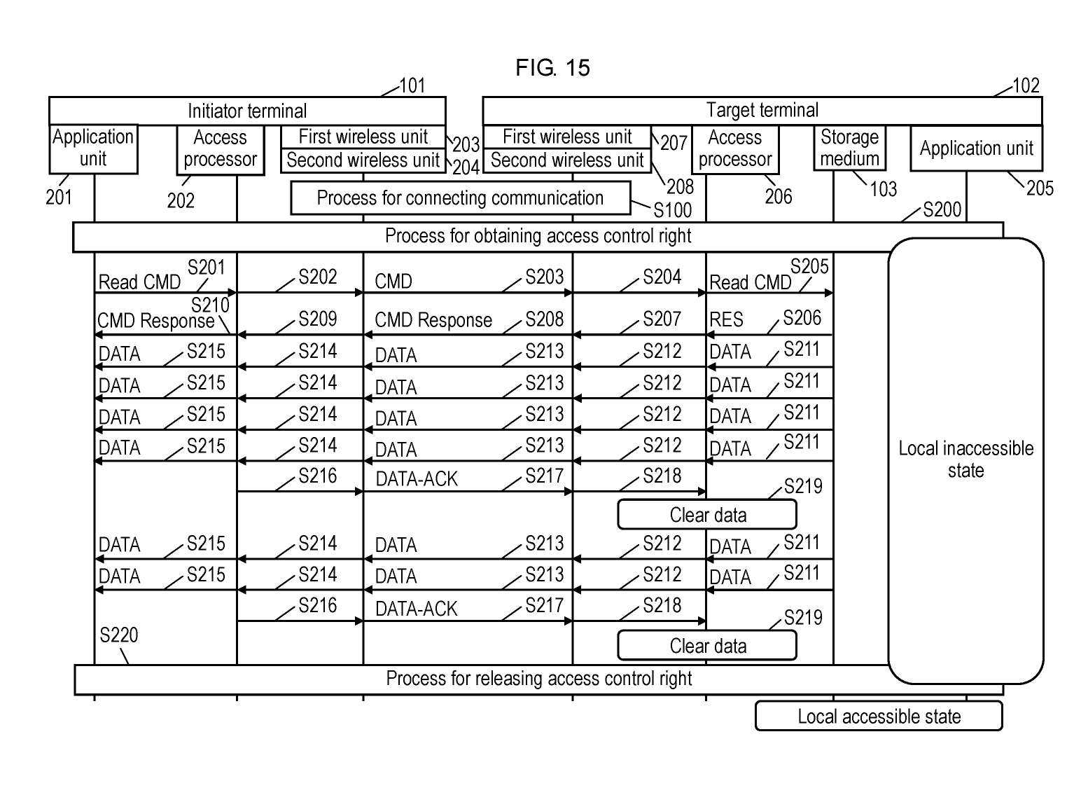

A sequence in which initiator terminal 101 accesses to storage medium 103 for reading is described below. FIG. 15 is a diagram describing a sequence where an initiator terminal reads data from a storage medium in a target terminal.

(Step S100) As already described, initiator terminal 101 and target terminal 102 connect with each other by wireless communication so that initiator terminal 101 accesses to storage medium 103.

(Step S200) Further, as described above, initiator terminal 101 executes steps from step S101 to step S121 that obtain an access control right t to storage medium 103 in target terminal 102.

If initiator terminal 101 obtains the access control right to storage medium 103, application unit 201 in initiator terminal 101 enables to access to storage medium 103 in target terminal 102.

Since target terminal 102 requests application unit 205 to release the access control right to storage medium 103, application unit 205 in target terminal 102 cannot access to storage medium 103. And then target terminal 102 is into a local inaccessible state.

(Step S201) Application unit 201 in initiator terminal 101 notifies access processor 202 of a Data Read Command (Read CMD). It is assumed that an amount of data to be read from storage medium 103 is 45 Kbyte.

(Step S202) Receiving an instruction for reading data of 45 Kbyte from application unit 201, access processor 202 generates a CMD packet. Information indicating a Read CMD (Read Command) and information indicating 45 Kbyte as size information of data to be read are stored in CMD 64. Since this is a packet for accessing that is generated first, 0 is stored as a value to be stored in PSN 65.

(Step S203) First wireless unit 203 or second wireless unit 204 wirelessly transmits the wireless packet generated by access processor 202 to target terminal 102.

(Step S204) First wireless unit 207 or second wireless unit 208 notifies access processor 206 of the received wireless packet.

(Step S205) Access processor 206 interprets the received wireless packet, and notifies storage medium 103 of the Read CMD.

(Step S206) Receiving the Read CMD, storage medium 103 responds RES (response) to the Read CMD to access processor 206.

(Step S207) Receiving RES from storage medium 103, access processor 206 generates a CMD Response packet that is a wireless packet for responding to the CMD packet, and outputs the generated packet to first wireless unit 207 or second wireless unit 208. Information about RES is stored in CMD Response 74, and 0 is stored in PSN 75.

(Step S208) First wireless unit 207 or second wireless unit 208 transmits the wireless packet generated by access processor 206 to initiator terminal 101.

(Step S209) Receiving the CMD Response packet, first wireless unit 203 or second wireless unit 204 in initiator terminal 101 notifies access processor 202 of the CMD Response packet.

(Step S210) Access processor 202 interprets the received CMD Response packet, and outputs a CMD Response to application unit 201. Receiving the CMD Response, application unit 201 confirms that the Read CMD is notified to storage medium 103.

(Step S211) Since target terminal 102 accepts the Read CMD, target terminal 102 reads DATA specified by the Read CMD from storage medium 103, and outputs the DATA to access processor 206. It is assumed that an amount of data to be transmitted at one time is 7.5 Kbyte.

(Step S212) Access processor 206 stores the DATA read from storage medium 103 in DATA 84 of the DATA packet. 0 is incremented and 1 is stored in PSN 85. Access processor 206 outputs the DATA packet to first wireless unit 207 or second wireless unit 208.

Further, access processor 206 holds the DATA read from storage medium 103 in an internal memory, not shown in the figure, in target terminal 102.

(Step S213) First wireless unit 207 or second wireless unit 208 transmits the DATA packet generated by access processor 206 to first wireless unit 203 or second wireless unit 204.

(Step S214) First wireless unit 203 or second wireless unit 204 receives the DATA packet transmitted from target terminal 102 and outputs the DATA packet to access processor 202.

(Step S215) Access processor 202 extracts DATA from the DATA packet and outputs the DATA to application unit 201. Access processor 202 subtracts a size of the received DATA from a data size requested to storage medium 103, and holds a remaining data size. That is to say, 7.5 Kbyte that is the size of the received DATA is subtracted from 45 Kbyte and 37.5 Kbyte that is the remaining data size is held.

The process at steps S211 to S215 is repeated until all data are read, namely, the remaining data size becomes 0 at step S215. The process at step S211 to S215 is executed six times in FIG. 15. In the DATA packet transmitted from access processor 206 to initiator terminal 101, PSN 85 is incremented at every time of transmitting.

(Step S216) While initiator terminal 101 reads data from storage medium 103, access processor 202 replies to access processor 206 in target terminal 102 about a data acknowledgment (DATA-ACK) indicating that access processor 206 properly reads the data. In FIG. 15, access processor 202 replies to access processor 206 about the data acknowledgment after the fourth DATA is read from storage medium 103. Access processor 202 generates an ACK packet. Access processor 202 inserts information indicating DATA-ACK into ACK 94. Since access processor 202 receives the DATA four times, a size of the received DATA is 30 Kbyte, 15 Kbyte as a remaining size is stored in Remaining Size 96.

Further, in FIG. 15, access processor 202 also replies to access processor 206 about DATA-ACK after the sixth DATA is read from storage medium 103. Since access processor 202 receives the DATA six times, and a size of the received DATA is 45 Kbyte, 0 Kbyte as a remaining size is stored in Remaining Size 96.

Access processor 202 outputs the generated ACK packet to first wireless unit 203 or second wireless unit 204.

The process at steps S217 to S219 is executed with respect to step S216 which replies the data acknowledgment after the fourth DATA and the sixth DATA are read from storage medium 103.

(Step S217) First wireless unit 203 or second wireless unit 204 wirelessly transmits the ACK packet requested by access processor 202 to first wireless unit 207 or second wireless unit 208.

(Step S218) First wireless unit 207 or second wireless unit 208 notifies access processor 206 of the ACK packet received from initiator terminal 101.

(Step S219) Access processor 206 interprets the received ACK packet, and confirms that the data transmitted from target terminal 102 to initiator terminal 101 is normally received by initiator terminal 101. After this confirmation, access processor 206 discards the transmitted data held in the internal memory, not shown in the figure, in target terminal 102.

A timing replying about a DATA-ACK may be determined the number of DATA-ACK in advance, or may be any timing, while initiator terminal 101 obtains the access control right.

(Step S220) Initiator terminal 101 received desired data from storage medium 103, executes a process for releasing the access control right to storage medium 103. As already described, the process at steps S122 to S129 are executed in which initiator terminal 101 releases the access control right to storage medium 103 in target terminal 102.

If the process for releasing the access control right is terminated, the access control right to storage medium 103 returns to target terminal 102, and target terminal 102 is into a local accessible state.

As a result, initiator terminal 101 can read data from storage medium 103 in target terminal 102. Since accessing to storage medium 103 is managed by switching the access control right, reading data from storage medium 103 can be exclusively controlled.

Further, a command transmitted from application unit 201 to storage medium 103, and data read from storage medium 103 to application unit 201 are encapsulated and are transmitted via wireless communication. Therefore, the command can be transmitted from application unit 201 and the data can be read from storage medium 103 regardless of a halfway route of the wireless communication. As a result, even if application unit 201 and storage medium 103 are in different terminals, the transparent access is enabled as if they are in the same terminal.

The above description is a sequence in which initiator terminal 101 accesses to read from storage medium 103 without an error.

1-5. Error Recovery Operation If A Data Loss Occurs

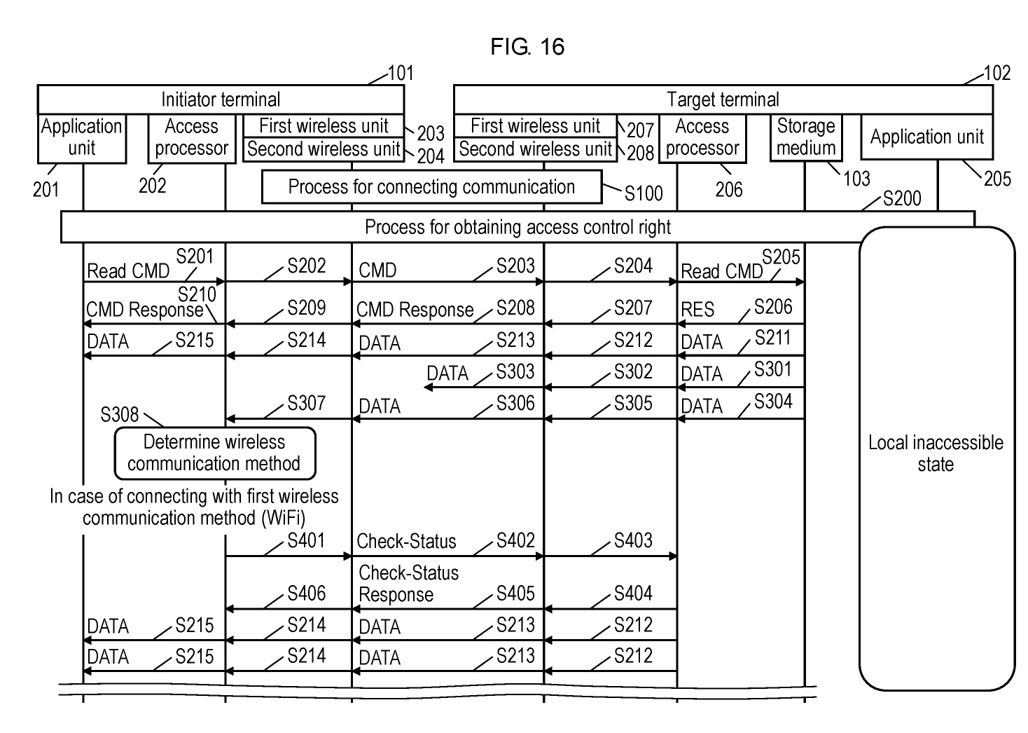

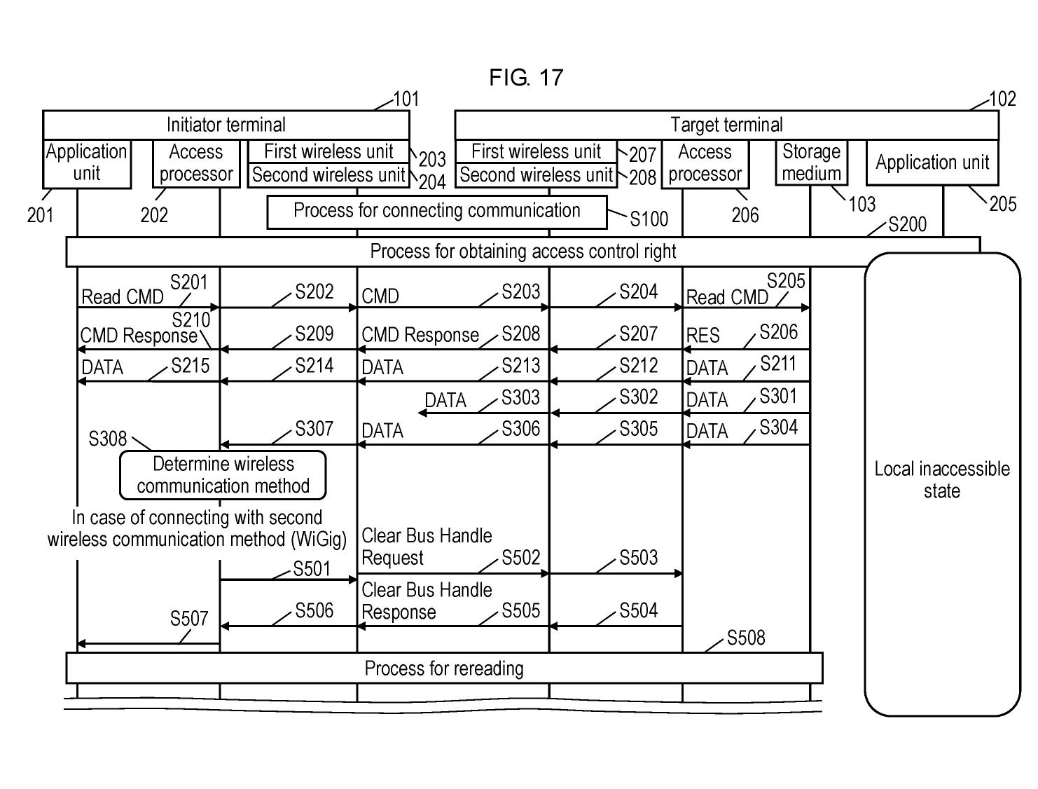

An error recovery process if a data loss occurs during reading data is described below. FIG. 16 is a diagram describing a sequence if a data loss occurs during reading data from the storage medium in the target terminal by the initiator terminal. FIG. 17 is a diagram describing another sequence if a data loss occurs during reading data from the storage medium in the target terminal by the initiator terminal. FIG. 16 illustrates a sequence that the wireless communication method between the initiator terminal and the target terminal is the first wireless communication method. FIG. 17 illustrates a sequence that the wireless communication method between the initiator terminal and the target terminal is the second wireless communication method.

In FIGS. 16 and 17, a process for connecting a wireless communication at step S100, a process for obtaining access control right at step S200, a process at steps S201 to S210, a process for transmitting the first DATA at steps S211 to S215 are as described above.

(Step S301) The second DATA is read from storage medium 103 to access processor 206.

(Step S302) Access processor 206 stores the DATA read from storage medium 103 in DATA 84 of the DATA packet. In PSN 85, 1 is incremented and 2 is stored. Access processor 206 outputs the DATA packet to first wireless unit 207 or second wireless unit 208.

Further, access processor 206 holds the DATA read from storage medium 103 in the internal memory, not shown in the figure, in target terminal 102.

(Step S303) First wireless unit 207 or second wireless unit 208 transmits the DATA packet generated by access processor 206 to initiator terminal 101, but the DATA packet is not transmitted and a data loss occurs. Therefore, the process at steps S214 and S215 is not executed.

(Step S304) The third DATA is read from storage medium 103 to access processor 206.

(Step S305) Access processor 206 stores the DATA read from storage medium 103 in DATA 84 of the DATA packet. In PSN 85, 2 is incremented and 3 is stored. Access processor 206 outputs the DATA packet to first wireless unit 207 or second wireless unit 208.

Further, access processor 206 holds the DATA read from storage medium 103 in the internal memory, not shown in the figure, in target terminal 102.

(Step S306) First wireless unit 207 or second wireless unit 208 transmits the DATA packet generated by access processor 206 to first wireless unit 203 or second wireless unit 204.

(Step S307) First wireless unit 203 or second wireless unit 204 receives the DATA packet transmitted from target terminal 102, and outputs the DATA packet to access processor 202. Access processor 202 interprets the DATA packet. Since PSN 85 is 3, access processor 202 detects that 2 in PSN 85 is not received.

(Step S308) Access processor 202 determines whether the wireless communication method between initiator terminal 101 and target terminal 102 is the wireless communication using the first wireless communication method or the wireless communication using the second wireless communication method. For example, at the time that the process of connecting wireless communication is executed, whether which a wireless communication system is used for the connection, is stored in a memory, not shown in the figure, in initiator terminal 101. And access processor 202 confirms a using wireless communication method from information in the memory.

FIG. 16 illustrates a process if initiator terminal 101 connects with target terminal 102 via wireless communication with the first wireless communication method.

(Step S401) Access processor 202 instructs first wireless unit 203 to transmit a Check-Status packet to first wireless unit 207 in order to confirm if an error is a data loss. 2 in PSN to be expected next is stored in Next PSN 1007 in the Check-Status packet. Further, 37.5 Kbyte that is the remaining size is stored in Remaining Size 1006.

(Step S402) First wireless unit 203 transmits the Check-Status packet to first wireless unit 207.

(Step S403) First wireless unit 207 notifies access processor 206 of the Check-Status packet. Access processor 206 interprets the Check-Status packet, and detects that the second DATA packet cannot be transmitted to initiator terminal 101.

(Step S404) Access processor 206 instructs first wireless unit 207 to transmit the Check-Status Response packet in response to the Check-Status Request packet.

4 in PSN of the DATA to be transmitted next by target terminal 102 is stored in Next PSN 1107 of the Check-Status Response packet. Since the third DATA has been transmitted, remaining 22.5 Kbyte is stored in Remaining Size 1106.

(Step S405) First wireless unit 207 transmits the Check-Status Response packet to first wireless unit 203.

(Step S406) Receiving the Check-Status Response packet, first wireless unit 203 notifies access processor 202 of the Check-Status Response packet.

Access processor 202 interprets the Check-Status Response packet, and confirms where a data loss occurs. In FIG. 16, access processor 202 confirms that the second DATA is lost.

Target terminal 102 restarts to transmit the second DATA, and repeats the process at steps S211 to S215 until all the data are read, namely, the remaining data size becomes 0. The second and third DATA are not executed a process at step S211, and are executed a process at step S212 by using the DATA held in the internal memory.

As described above, if a data loss occurs during transmitting data and receiving data using the first wireless unit to connect with a target terminal via wireless communication with the first wireless communication method, the initiator terminal sends a packet for confirming if an error is a data loss during accessing to the storage medium, and the target terminal sends a packet indicating a data loss. As a result, if an error occurs, it is possible to avoid the error and to prepare for retransmitting data. Further, the initiator terminal retransmits data from the lost data to the target terminal. As a result, retransmitting data can be realized.

Further, retransmitting data is not read from storage medium 103, the retransmitting data is obtained from the memory that holds the read data, and the retransmitting data can be more quickly.

FIG. 17 illustrates a process if initiator terminal 101 connects with target terminal 102 via wireless communication with the second wireless communication method.

(Step S501) Access processor 202 instructs second wireless unit 204 to transmit the Clear Bus Handle Request packet. In the Clear Bus Handle Request packet, 0 is stored in PSN 1205.

(Step S502) Second wireless unit 204 transmits the Clear Bus Handle Request packet to second wireless unit 208.

(Step S503) Second wireless unit 208 notifies access processor 206 of the Clear Bus Handle Request packet.

(Step S504) Receiving the Clear Bus Handle Request packet, access processor 206 instructs second wireless unit 204 to transmit a Clear Bus Handle Response packet as a response.

If the data read from storage medium 103 is held in the memory, access processor 206 may clear the memory or may hold the read data.

(Step S505) Second wireless unit 208 transmits the Clear Bus Handle Response packet to second wireless unit 204.

(Step S506) Second wireless unit 204 notifies access processor 202 of the Clear Bus Handle Response packet.

(Step S507) Access processor 202 interprets the Clear Bus Handle Response packet, and notifies application unit 201 of a failure of the communication with target terminal 102.

(Step S508) Receiving the failure of the communication, application unit 201 notifies access processor 202 of the Read CMD again. Therefore, the process at steps S201 to S219 is executed again.

As described above, if a data loss occurs during transmitting data and receiving data using the second wireless unit to connect with the target terminal via wireless communication with the second wireless communication method, the initiator terminal interrupts accessing to the storage medium, and the target terminal interrupts accessing to the recording medium. As a result, if an error occurs, it is possible to avoid the error. Further, the initiator terminal executes to read the data from the beginning. As a result, retransmitting data can be realized.

1-6. Effect

In the exemplary embodiment, initiator terminal 101 includes first wireless unit 203 configured to connect with target terminal 102 via the wireless communication with the first wireless communication method, second wireless unit 204 configured to connect with target terminal 102 via the wireless communication with the second wireless communication method different from the first wireless communication method, and access processor 202 configured to execute the access protocol process for remote access to storage medium 103 that target terminal 102 includes. If an error occurs during accessing to storage medium 103, access processor 202 switches the access protocol process for remote access to storage medium 103 between in the wireless communication in first wireless unit 203 and in the wireless communication in the second wireless unit 204. Further, target terminal 102 includes storage medium 103, first wireless unit 207 configured to connect with initiator terminal 101 via the wireless communication with the first wireless communication method, second wireless unit 208 configured to connect with initiator terminal 101 via the wireless communication with the second wireless communication method different from the first wireless communication method, and access processor 206 configured to permit initiator terminal 101 to access remotely to storage medium 103 and to execute an access protocol process for the remote access to storage medium 103. If an error occurs during accessing to storage medium 103, access processor 206 switches the access protocol process for remote access to storage medium 103 between in the wireless communication in first wireless unit 207 and in the wireless communication in second wireless unit 208.

As a result, a recovering process for reading data can be executed suitably according to a using wireless communication method if an error occurs.

Further, in initiator terminal 101 according to this exemplary embodiment, as the access protocol process for the error, access processor 202 transmits a packet for checking whether the error during accessing to storage medium 103 is a data loss in the wireless communication in first wireless unit 203 and access processor 202 interrupts the access protocol process to storage medium 103 in wireless communication in second wireless. In target terminal 102, as the access protocol process for the error, access processor 206 transmits a packet indicating that an error during accessing to storage medium 103 is a data loss in the wireless communication in first wireless unit 207, and access processor 206 interrupts the access protocol process for remote access to storage medium 103 in the wireless communication in second wireless unit 208.

As a result, if an error occurs, it is possible to avoid the error according to a using wireless communication method.

Further, in initiator terminal 101 according to this exemplary embodiment, as the access protocol process for the error, access processor 202 retransmits data from data that the error has occurred in the wireless communication in first wireless unit 203, and access processor 202 retransmits data from data before the error has occurred in the wireless communication in second wireless unit 204. In target terminal 102, as the access protocol process for the error, access processor 206 retransmits data from data that the error has occurred in the wireless communication in first wireless unit 207, and access processor 206 retransmits data from data before the error has occurred in the wireless communication in second wireless unit 208.

As a result, retransmitting data for a reading process can be realized according to a using wireless communication method.

Further, in first wireless unit 203 of initiator terminal 101 according to this exemplary embodiment, a communication speed is slower than a communication speed of second wireless unit 204. In first wireless unit 207 of target terminal 102, a communication speed is slower than a communication speed of second wireless unit 208.

As a result, a process for an error can be realized according to a communication speed of a using wireless communication method.

Further, in initiator terminal 101 according to this exemplary embodiment, in the access protocol process for the error in access processor 202, an amount of data retransmitted in the wireless communication in first wireless unit 203 is smaller than an amount of data retransmitted in the wireless communication in second wireless unit 204. In target terminal 102, in the access protocol process for the error in access processor 206, an amount of data retransmitted in the wireless communication in first wireless unit 207 is smaller than an amount of data retransmitted in the wireless communication in second wireless unit 208.

As a result, an amount of data retransmitted in a process for an error can be switched according to a communication speed of a using wireless communication method.

Further, in initiator terminal 101 according to this exemplary embodiment, the first wireless communication method is WiFi, and the second wireless communication method is WiGig. In target terminal 102, the first wireless communication method is WiFi, and the second wireless communication method is WiGig.

As a result, a process for an error can be suitably executed according to the using wireless communication method, namely, WiFi or WiGig.

In this exemplary embodiment, in the case of the first wireless communication method that is comparatively slower like WiFi, if a data loss occurs, data is read from the lost data again. In the case of the second wireless communication method that is comparatively faster like WiGig, if a data loss occurs, data is read from the beginning.

In the case of the wireless communication method that is comparatively slower, the process for reading data is started from the beginning, a comparatively longer time a process for retransmitting is required. On the contrary, in the case of the wireless communication method that is comparatively faster, the process for retransmitting is started from a lost data, the control may be complicated.

Therefore, in this exemplary embodiment, a process for an error is switched according to wireless communication methods, and retransmitting data can be realized suitably according to each of wireless communication methods.

Further, since a transparent access is enabled between application unit 201 in initiator terminal 101 and storage medium 103 in target terminal 102, retransmitting data to an upper layer such as application unit 201 is enabled without awareness of connecting.

By the above, an initiator terminal and a target terminal that include a plurality of wireless communication methods, can efficiently execute a recovering process for transmitting data and receiving data if an error occurs.

### Second Exemplary Embodiment

An exemplary embodiment describes a case where an initiator terminal writes data to a storage medium in a target terminal. Since a configuration of a wireless communication system, procedures for obtaining and releasing an access control right and a data format of packets for accessing are similar to the first exemplary embodiment with reference to FIGS. 1 to 14.

2-1. Normal Operation for Writing Data

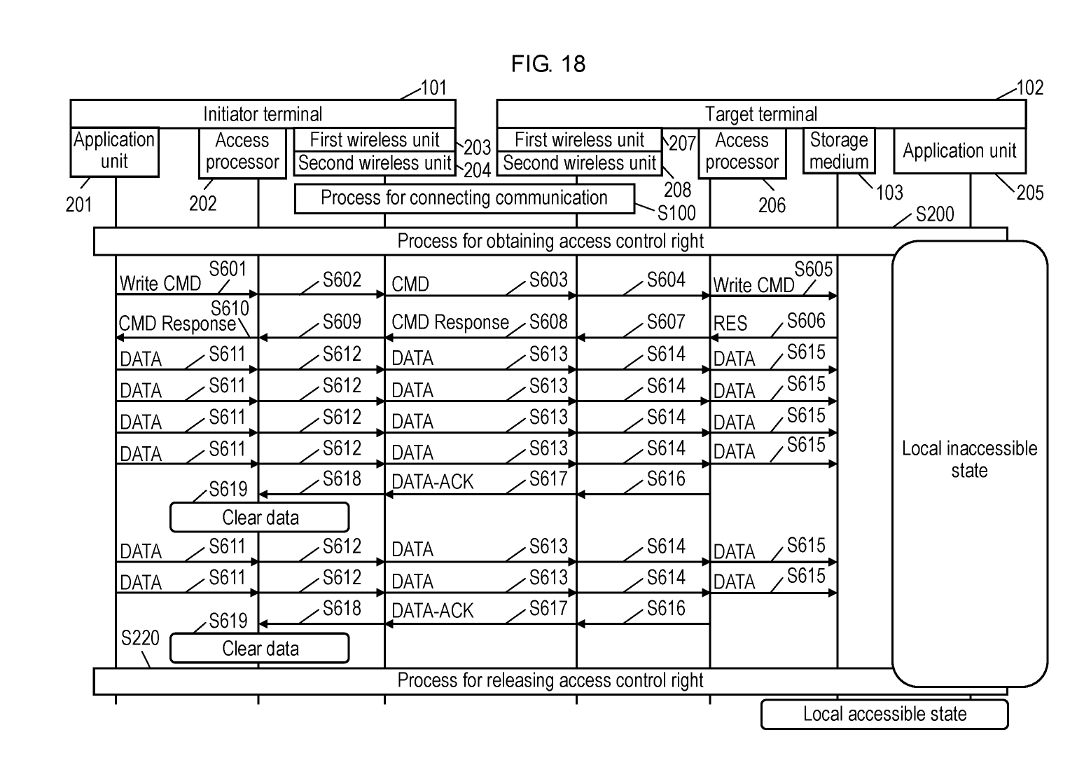

FIG. 18 is a diagram describing a sequence where the initiator terminal writes data in the storage medium in the target terminal.

(Step S100) As described in the first exemplary embodiment, initiator terminal 101 and target terminal 102 connect with each other by wireless communication so that initiator terminal 101 accesses to storage medium 103.

(Step S200) Further, as described in the first exemplary embodiment, initiator terminal 101 executes steps from step S101 to step S121 that obtain an access control right to storage medium 103 in target terminal 102.

If initiator terminal 101 obtains the access control right to storage medium 103, application unit 201 in initiator terminal 101 enables to access to storage medium 103 in target terminal 102.

Since target terminal 102 requests application unit 205 to release the access control right to storage medium 103, application unit 205 in target terminal 102 cannot access to storage medium 103. And then target terminal 102 is into a local inaccessible state.

(Step S601) Application unit 201 in initiator terminal 101 outputs a Data Write Command (Write CMD) to access processor 202. It is assumed that an amount of data to be written in storage medium 103 is 45 Kbyte.

(Step S602) Receiving an instruction for writing data from application unit 201, access processor 202 generates a CMD packet. Information indicating the Write CMD (Data Write Command) and information indicating 45 Kbyte as size information of data to be written are stored in CMD 64. Since this is a packet for accessing that is generated first, 0 is stored as a value to be stored in PSN 65.

(Step S603) First wireless unit 203 or second wireless unit 204 wirelessly transmits the CMD packet to target terminal 102.

(Step S604) First wireless unit 207 or second wireless unit 208 notifies access processor 206 of the received wireless packet.

(Step S605) Access processor 206 interprets the received wireless packet, and notifies storage medium 103 of the Write CMD.

(Step S606) Receiving the Write CMD, storage medium 103 responds RES (response) to the Write CMD to access processor 206.

(Step S607) Receiving RES from storage medium 103, access processor 206 generates a CMD Response packet that is a wireless packet for responding to the CMD packet, and outputs the generated packet to first wireless unit 207 or second wireless unit 208. Information about RES is stored in CMD Response 74, and 0 is stored in PSN 75.

(Step S608) First wireless unit 207 or second wireless unit 208 transmits the wireless packet generated by access processor 206 to initiator terminal 101.

(Step S609) Receiving the CMD Response packet, first wireless unit 203 or second wireless unit 204 in initiator terminal 101 notifies access processor 202 of the CMD Response packet.

(Step S610) Access processor 202 interprets the CMD Response packet, and outputs the CMD Response packet to application unit 201. Receiving the CMD Response packet, application unit 201 confirms that the Write CMD is notified to storage medium 103.

(Step S611) Application unit 201 divides data (DATA) written in storage medium 103 into a predetermined size, here 7.5 Kbyte and outputs the divided DATA to access processor 202.

(Step S612) Access processor 202 stores the DATA received from application unit 201 in DATA 84 of the DATA packet, and 0 is incremented and 1 is stored in PSN 85. Access processor 202 outputs the DATA packet generated to first wireless unit 203 or second wireless unit 204.

Access processor 202 holds the DATA received from application unit 201 in the internal memory, not shown in the figure, in initiator terminal 101.

(Step S613) First wireless unit 203 or second wireless unit 204 transmits the DATA packet generated by access processor 202 to first wireless unit 207 or second wireless unit 208.

(Step S614) First wireless unit 207 or second wireless unit 208 receives the DATA packet transmitted from initiator terminal 101 and outputs the DATA packet to access processor 206.

(Step S615) Access processor 206 extracts DATA from the DATA packet and outputs the DATA to storage medium 103 and writes the DATA in storage medium 103.

Access processor 206 subtracts a size of the received DATA from a data size requested to be written in storage medium 103, and holds a remaining data size. That is to say, 7.5 Kbyte that is the size of the received DATA is subtracted from 45 Kbyte and 37.5 Kbyte that is the remaining data size is held.

The process at steps S611 to S615 is repeated until all data are written, namely, the remaining data size becomes 0 at step S615. The process at steps S611 to S615 is executed six times in FIG. 18. In the DATA packet transmitted from access processor 202 to target terminal 102, PSN 85 is incremented every time of transmitting.

(Step S616) While initiator terminal 101 writes data in storage medium 103, access processor 206 replies to access processor 202 in initiator terminal 101 about a data acknowledgment (DATA-ACK) indicating that access processor 206 properly transmits the data. In FIG. 18, access processor 202 replies to access processor 206 about the data acknowledgment after fourth DATA is read. Access processor 206 generates an ACK packet. Access processor 206 inserts information indicating DATA-ACK into ACK 94. Since access processor 202 receives the DATA four times, a size of the received DATA is 30 Kbyte, 15 Kbyte as a remaining size is stored in Remaining Size 96.

Further, in FIG. 18, access processor 202 also replies to access processor 206 about DATA-ACK after sixth DATA is read. Since access processor 202 receives the DATA six times, and a size of the received DATA is 45 Kbyte, 0 Kbyte as a remaining size is stored in Remaining Size 96.

Access processor 206 outputs the ACK packet to first wireless unit 207 or second wireless unit 208.

The process at steps S617 to S619 is executed with respect to step S616 which replies the data acknowledgement after the fourth DATA and the sixth DATA are read.

(Step S617) First wireless unit 207 or second wireless unit 208 wirelessly transmits the ACK packet requested by access processor 206 to first wireless unit 203 or second wireless unit 204.

(Step S618) First wireless unit 203 or second wireless unit 204 notifies access processor 202 of the ACK packet received from target terminal 102.

(Step S619) Access processor 202 interprets the received ACK packet, and confirms that the data transmitted to target terminal 102 is normally received by target terminal 102. After this confirmation, access processor 202 discards the transmitted data held in the internal memory, not shown in the figure, in initiator terminal 101.

A timing replying about a DATA-ACK may be determined the number of DATA-ACK in advance, or may be any timing.

(Step S220) Initiator terminal 101 transmitted desired data to storage medium 103, executes a process for releasing the access control right to storage medium 103. As described in the first exemplary embodiment, the process at steps S122 to S129 are executed in which initiator terminal 101 releases the access control right to storage medium 103 in target terminal 102.

By the above, initiator terminal 101 can write data in storage medium 103 in target terminal 102. Since accessing to storage medium 103 is managed by switching the access control right, writing data in storage medium 103 can be exclusively controlled.

Further, a data write command transmitted from application unit 201 to storage medium 103, and data written from storage medium 103 are encapsulated and are transmitted via wireless communication. Therefore, the command and the data can be transmitted to application unit 201 or storage medium 103 and received from application unit 201 or storage medium 103 regardless of a halfway route of the wireless communication. As a result, even if application unit 201 and storage medium 103 are in different terminals, the transparent access is enabled as if they are in the same terminal.

The above description is a sequence in which initiator terminal 101 accesses to write to storage medium 103without an error.

2-2. Error Recovery Operation If A Data Loss Occurs

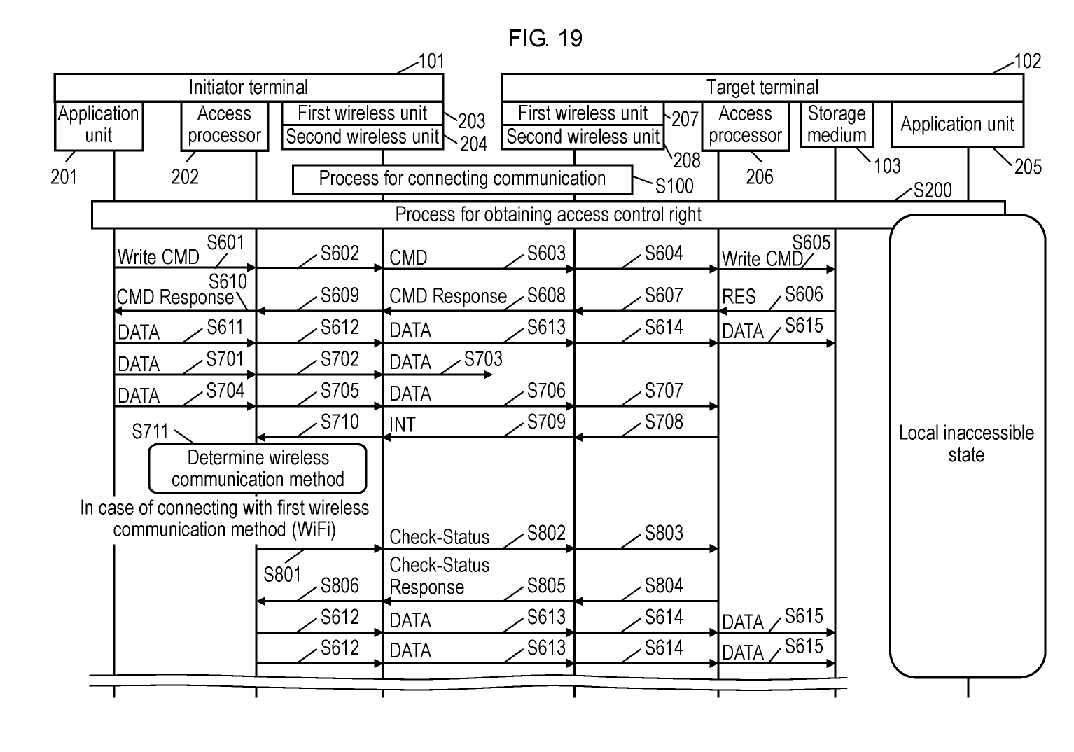

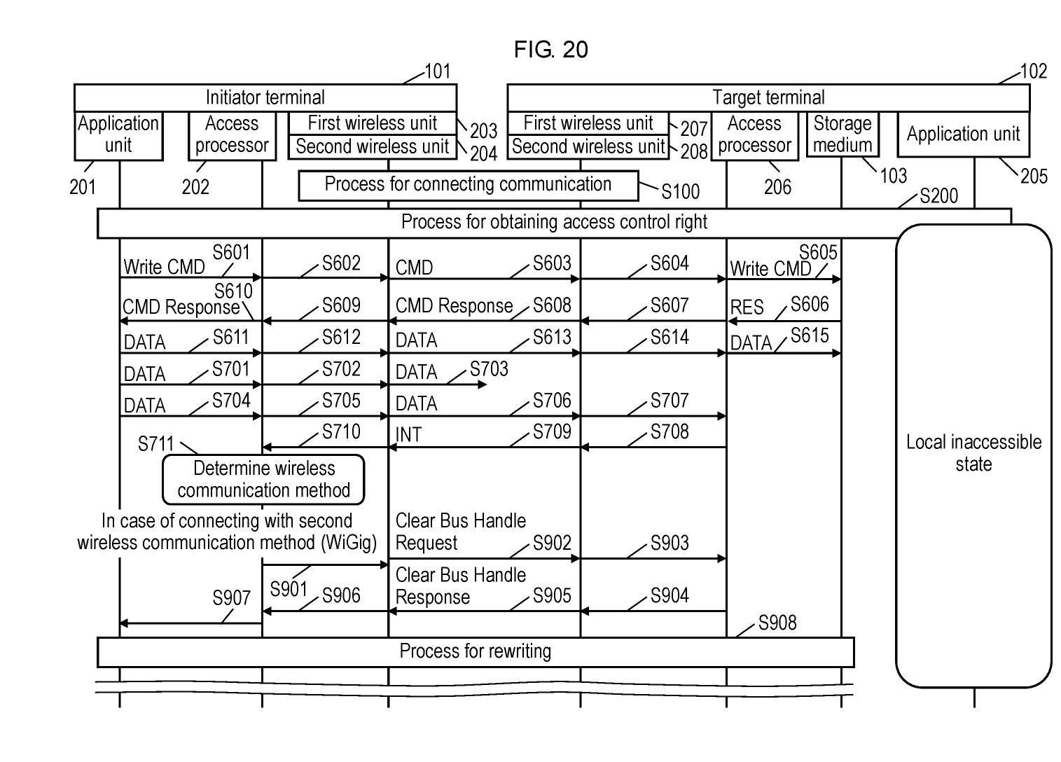

An error recovery process if a data loss occurs during writing data is described below. FIG. 19 is a diagram describing a sequence if a data loss occurs during writing data in the storage medium in the target terminal by the initiator terminal. FIG. 20 is a diagram describing another sequence if a data loss occurs during writing data in the storage medium in the target terminal by the initiator terminal. FIG. 19 illustrates a sequence that the wireless communication method between the initiator terminal and the target terminal is the first wireless communication method. FIG. 20 illustrates a sequence that the wireless communication method between the initiator terminal and the target terminal is the second wireless communication method.

In FIGS. 19 and 20, a process for connecting a wireless communication at step S100, a process for obtaining the access control right at step S200, a process at steps S601 to S610, and a process for transmitting the first DATA at steps S611 to S615 are as described above.

(Step S701) The second DATA is transmitted from application unit 201 to access processor 202.

(Step S702) Access processor 202 stores the DATA transmitted from application unit 201 in DATA 84 of the DATA packet. In PSN 85, 1 is incremented, and 2 is stored. Access processor 202 outputs the DATA packet to first wireless unit 203 or second wireless unit 204.

Further, access processor 202 holds the DATA transmitted from application unit 201 in the internal memory, not shown in the figure, in initiator terminal 101.

(Step S703) First wireless unit 203 or second wireless unit 204 transmits the DATA packet generated by access processor 202 to target terminal 102, but the DATA packet is not transmitted and a data loss occurs. Therefore, the process at steps S614 and S615 is not executed.

(Step S704) The third DATA is transmitted from application unit 201 to access processor 202.

(Step S705) Access processor 202 stores the DATA transmitted from application unit 201 in DATA 84 of the DATA packet. In PSN 85, 2 is incremented and 3 is stored. Access processor 202 outputs a DATA packet to first wireless unit 203 or second wireless unit 204.

Further, access processor 202 holds the DATA transmitted from application unit 201 in the internal memory, not shown in the figure, in initiator terminal 101.

(Step S706) First wireless unit 203 or second wireless unit 204 transmits the DATA packet generated by access processor 202 to first wireless unit 207 or second wireless unit 208.

(Step S707) First wireless unit 207 or second wireless unit 208 receives the DATA packet transmitted from initiator terminal 101, and outputs the DATA packet to access processor 206. Access processor 206 interprets the DATA packet. Since PSN 85 is 3, access processor 202 detects that 2 in PSN 85 is not received.

(Step S708) Detecting the received data loss, access processor 206 instructs initiator terminal 101 to transmit an INT packet. 0 is stored in PSN 1405 of the INT packet, and information indicating the received data loss is stored in Event Type 1406.

(Step S709) First wireless unit 207 or second wireless unit 208 wirelessly transmits the INT packet to initiator terminal 101.

(Step S710) First wireless unit 203 or second wireless unit 204 notifies access processor 202 of the received INT packet.

(Step S711) Access processor 202 determines whether the wireless communication method between initiator terminal 101 and target terminal 102 is the wireless communication using the first wireless communication method or the wireless communication using the second wireless communication method. For example, at the time that the process of connecting wireless communication is executed, whether which a wireless communication method is used for the connection, is stored in a memory, not shown in the figure, in initiator terminal 101. And access processor 202 confirms the wireless communication method used for the connection in the memory.

FIG. 19 illustrates a process if initiator terminal 101 connects with target terminal 102 via wireless communication with the first wireless communication method.

(Step S801) Access processor 202 instructs first wireless unit 203 to transmit a Check-Status packet to first wireless unit 207 in order to confirm if an error is a writing data loss. 4 in PSN to be transmitted next is stored in Next PSN 1007 in the Check-Status packet. Further, 22.5 Kbyte that is the remaining size is stored in Remaining Size 1006.

(Step S802) First wireless unit 203 transmits the Check-Status packet to first wireless unit 207.

(Step S803) First wireless unit 207 notifies access processor 206 of the Check-Status packet. Access processor 206 interprets the Check-Status packet, and detects that a second DATA packet cannot be received from initiator terminal 101.

(Step S804) Access processor 206 generates a Check-Status Response packet for initiator terminal 101.

0 is stored in PSN 1105. Access processor 206 stores 2 that is PSN expected to be received next in Next PSN 1107. Since the first DATA is received, remaining 37.5 Kbyte is stored in Remaining Size 1106.

Access processor 206 notifies first wireless unit 207 of the generated Check-Status Response packet.

(Step S805) First wireless unit 207 wirelessly transmits the Check-Status Response packet to first wireless unit 203.

(Step S806) First wireless unit 203 notifies access processor 202 of the received Check-Status Response packet.

Access processor 202 interprets the Check-Status Response packet, and confirms where a data loss occurs. In FIG. 19, access processor 202 confirms that the second DATA is lost.

Target terminal 102 restarts to transmit the second DATA, and repeats the process at steps S611 to S615 until all the data are read, namely, the remaining data size becomes 0. The second and third DATA are not executed a process at step S611, and are executed a process at step S612 by using the DATA held in the internal memory.

As described above, if a data loss occurs during transmitting data and receiving data using the first wireless unit to connect with the target terminal via wireless communication with the first wireless communication method, the initiator terminal transmits a packet for confirming if an error is a data loss during accessing to a storage medium, and the target terminal transmits a packet indicating a data loss. As a result, if an error occurs, it is possible to avoid the error and to prepare for retransmitting data. Further, the target terminal retransmits data to the initiator terminal from the lost data. As a result, retransmitting data can be realized.

FIG. 20 illustrates a process if initiator terminal 101 connects with target terminal 102 via wireless communication with the second wireless communication method.

(Step S901) Access processor 202 instructs second wireless unit 204 to transmit a Clear Bus Handle Request packet. In the Clear Bus Handle Request packet, 0 is stored in PSN 1205.

(Step S902) Second wireless unit 204 transmits the received Clear Bus Handle Request packet to second wireless unit 208.

(Step S903) Second wireless unit 208 notifies access processor 206 of the Clear Bus Handle Request packet.

(Step S904) Receiving the Clear Bus Handle Request packet, access processor 206 interrupts writing data in storage medium 103. At the same time, access processor 206 may delete data written in storage medium 103. Access processor 206 instructs second wireless unit 208 to transmit a Clear Bus Handle Response packet.

(Step S905) Second wireless unit 208 transmits the Clear Bus Handle Response packet to second wireless unit 204.

(Step S906) Second wireless unit 204 notifies access processor 202 of the Clear Bus Handle Response packet.

(Step S907) Access processor 202 interprets the Clear Bus Handle Response packet, and notifies application unit 201 of a failure of the communication with target terminal 102.

(Step S908) Receiving the failure of the communication, application unit 201 outputs the Write CMD again. As a result, the process at steps S601 to S619 is executed again.

As described above, if a data loss occurs during transmitting data and receiving data using the second wireless unit connect with a target terminal via wireless communication with the second wireless communication method, an initiator terminal interrupts accessing to the storage medium, and the target terminal interrupts accessing to the recording medium. As a result, if an error occurs, it is possible to avoid the error. Further, the initiator terminal executes to write the data from the beginning. As a result, retransmitting data can be realized.

2-3. Effects

In the exemplary embodiment, initiator terminal 101 includes first wireless unit 203 configured to connect with target terminal 102 via the wireless communication with the first wireless communication method, second wireless unit 204 configured to connect with target terminal 102 via the wireless communication with the second wireless communication method different from the first wireless communication method, and access processor 202 configured to execute the access protocol process for remote access to storage medium 103 that target terminal 102 includes. If an error occurs during accessing to storage medium 103, access processor 202 switches the access protocol process for remote access to storage medium 103 between in the wireless communication in first wireless unit 203 and in the wireless communication in second wireless unit 204. Further, target terminal 102 includes storage medium 103, first wireless unit 207 configured to connect with initiator terminal 101 via the wireless communication with the first wireless communication method, second wireless unit 208 configured to connect with initiator terminal 101 via the wireless communication of second wireless communication method different from the first wireless communication method, and access processor 206 configured to permit initiator terminal 103 to access remotely to storage medium 103 and to execute an access protocol process for remote access to storage medium 103. If an error occurs during accessing to storage medium 103, access processor 206 switches the access protocol process for remote access to storage medium 103 between in the wireless communication in first wireless unit 207 and inthe wireless communication in second wireless unit 208.

As a result, a writing process can be executed suitably according to a using wireless communication method if an error occurs.

Further, in initiator terminal 101 according to this exemplary embodiment, as the access protocol process for the error, access processor 202 transmits a packet for checking whether the error during accessing to storage medium 103 is a data loss in the wireless communication in first wireless unit 203 and access processor 202 interrupts the access protocol process to storage medium 103 in wireless communication in second wireless unit 204. In target terminal 102, as the access protocol process for the error, access processor 206 transmits a packet indicating that the error during accessing to storage medium 103 is a data loss in the wireless communication in first wireless unit 207, and access processor 206 interrupts the access protocol process for remote access to storage medium 103 in the wireless communication in second wireless unit 208.

As a result, if an error occurs, it is possible to avoid the error according to a using wireless communication method.

Further, in initiator terminal 101 according to this exemplary embodiment, as the access protocol process for an error, access processor 202 retransmits data from data that the error has occurred in the wireless communication in first wireless unit 203, and access processor 202 retransmits data from data before the error has occurred in the wireless communication in second wireless unit 204. In target terminal 102, as the access protocol process for the error, access processor 206 retransmits data from data that the error has occurred in the wireless communication in first wireless unit 207, and access processor 206 retransmits data from data before the error has occurred in the wireless communication in second wireless unit 208.

As a result, retransmitting data for a writing process can be realized according to a using wireless communication method.

Further, in initiator terminal 101 according to this exemplary embodiment, a communication speed of first wireless unit 203 is slower than a communication speed of second wireless unit 204. In target terminal 102, a communication speed of first wireless unit 207 is slower than a communication speed of second wireless unit 208.

As a result, the process for an error can be realized according to a communication speed of a using wireless communication method.

Further, in initiator terminal 101 according to this exemplary embodiment, in the access protocol process for the error in access processor 202, an amount of data retransmitted in the wireless communication in first wireless unit 203 is smaller than an amount of data retransmitted in the wireless communication in second wireless unit 204. In target terminal 102, in the access protocol process for the error in access processor 206, an amount of data retransmitted in the wireless communication in first wireless unit 207 is smaller than an amount of data retransmitted in the case of the wireless communication in second wireless unit 208.

As a result, an amount of data retransmitted in a process for an error can be switched according to a communication speed of a using wireless communication method.

Further, in initiator terminal 101 according to this exemplary embodiment, the first wireless communication method is WiFi, and the second wireless communication method is WiGig. In target terminal 102, the first wireless communication method is WiFi, and the second wireless communication method is WiGig.

As a result, a process for an error can be suitably executed according to the using wireless communication method, namely, WiFi or WiGig.

In this exemplary embodiment, in the case of the first wireless communication method that is comparatively slower like WiFi, if a data loss occurs, data is written from the lost data again. In the case of the second wireless communication method that is comparatively faster like WiGig, if a data loss occurs, data is written from the beginning.

In the case of the wireless communication method that is comparatively slower, the process for writing data is started from the beginning, a comparatively longer time a process for retransmitting is required. On the contrary, in the case of the wireless communication method that is comparatively faster, the process for retransmitting is started from a lost data, the control may be complicated.

Therefore, in this exemplary embodiment, a process for an error is switched according to wireless communication methods, and retransmitting data can be realized suitably according to each of wireless communication methods.

Further, since a transparent access is enabled between application unit 201 in initiator terminal 101 and storage medium 103 in target terminal 102, retransmitting data to an upper layer such as application unit 201 is enabled without awareness of connecting.

By the above, an initiator terminal and a target terminal that include a plurality of wireless communication methods, can efficiently execute a recovering process for transmitting data and receiving data if an error occurs.

### Another Exemplary Embodiment

The first and second exemplary embodiments describe the case where initiator terminal 101 and target terminal 102 can communicate with each other by the two wireless communication methods, but the present disclosure is not limited to it. Three or more different wireless communication methods may be provided.

Further, the present disclosure may be realized as a software program for controlling hardware provided to an initiator terminal and a target terminal. In this case, the software may be executed on a CPU, or may be realized on an integrated circuit.

### INDUSTRIAL APPLICABILITY

The present disclosure is applicable to an apparatus or a system for realizing to access a storage medium that an accessible external terminal includes, similarly to a storage medium that an own terminal includes, by using a plurality of wireless communication methods.

### REFERENCE MARKS IN THE DRAWINGS

100 wireless communication system
101 initiator terminal
102 target terminal
103 storage medium
201, 205 application unit
202, 206 access processor
203, 207 first wireless unit
204, 208 second wireless unit
41, 51, 61, 71, 81, 91, 1001, 1101, 1201, 1301, 1401 wireless packet header
42, 52, 62, 72, 82, 92, 1002, 1102, 1202, 1302, 1402 wireless packet payload
63, 73, 83, 93, 1003, 1103, 1203, 1303, 1403 control data 64 CMD
65, 75, 85, 95, 1005, 1105, 1205, 1305, 1405 PSN
74 CMD Response
84 DATA
94 ACK
96, 1006, 1106 Remaining Size
1004 Check-Status
1007, 1107 Next PSN
1104 Check-Status Response
1204 Clear Bus Handle Request
1304 Clear Bus Handle Response
1404 Interrupt
1406 Event Type

1. An initiator terminal comprising:
a first wireless unit configured to connect with a target terminal via wireless communication with a first wireless communication method;
a second wireless unit configure to connect with the target terminal via wireless communication with a second wireless communication method different from the first wireless communication method; and
an access processor configured to execute an access protocol process for remote access to a storage medium that the target terminal includes,
wherein if an error occurs during accessing to the storage medium, the access processor executes the access protocol process for remote access to the storage medium that is different in the wireless communication in the first wireless unit and in the wireless communication in the second wireless unit.

2. The initiator terminal according to claim 1, wherein
as the access protocol process for the error, the access processor transmits a packet for checking whether the error during accessing to the storage medium is a data loss in the wireless communication in the first wireless unit, and the access processor interrupts the access protocol process for remote access to the storage medium in wireless communication in the second wireless unit.

3. The initiator terminal according to claim 1, wherein
as the access protocol process for the error, the access processor retransmits all of data after data that the error has occurred in the wireless communication in the first wireless unit, and the access processor retransmits all of data after data before the error has occurred in the wireless communication in the second wireless unit.

4. The initiator terminal according to claim 1, wherein
a communication speed in the first wireless unit is slower than a communication speed in the second wireless unit.

5. The initiator terminal according to claim 4, wherein
in the access protocol process for the error in the access processor, an amount of data retransmitted in the wireless communication in the first wireless unit is smaller than an amount of data retransmitted in the wireless communication in the second wireless unit.

6. The initiator terminal according to claim 4, wherein
the first wireless communication method is Wireless Fidelity (WiFi), and
the second wireless communication method is Wireless Gigabit (WiGig).

7. A target terminal comprising:
a storage medium;
a first wireless unit configured to connect with an initiator terminal via wireless communication with a first wireless communication method;
a second wireless unit configured to connect with the initiator terminal via wireless communication with a second wireless communication method different from the first wireless communication method; and
an access processor configure to permit the initiator terminal to access remotely to the storage medium and to execute an access protocol process for remote access to the storage medium,
wherein if an error occurs during accessing to the storage medium from the initiator terminal, the access processor executes the access protocol process for remote access to the storage medium that is different in the wireless communication in the first wireless unit and in the wireless communication in the second wireless unit.

8. The target terminal according to claim 7, wherein,
as the access protocol process for the error, the access processor transmits a packet indicating that the error during accessing to the storage medium is a data loss in the wireless communication in the first wireless unit, and the access processor interrupts the access protocol process for remote access to the storage medium in the wireless communication in the second wireless unit.

9. The target terminal according to claim 7, wherein
as the access protocol process for the error, the access processor retransmits all of data after data that the error has occurred in the wireless communication in the first wireless unit, and, the access processor retransmits all of data after data before the error has occurred in the wireless communication in the second wireless unit.

10. The target terminal according to claim 7, wherein
a communication speed in the first wireless unit is slower than a communication speed in the second wireless unit.

11. The target terminal according to claim 7, wherein
in the access protocol process for the error in the access processor, an amount of data retransmitted in the wireless communication in the first wireless unit is smaller than an amount of data retransmitted in the wireless communication in the second wireless unit.

12. The target terminal according to claim 7, wherein
the first wireless communication method is Wireless Fidelity (WiFi), and
the second wireless communication method is Wireless Gigabit (WiGig).

13. An error processing method for an initiator terminal, the method comprising:
connecting with a target terminal via wireless communication with a first wireless communication method;
connecting with the target terminal via wireless communication with a second wireless communication method different from the first wireless communication method; and
executing an access protocol process for remote access to a storage medium that the target terminal includes,
wherein if an error occurs during accessing to the storage medium, executing the access protocol process for remote access to the storage medium that is different in the wireless communication with the first wireless communication method and in the wireless communication with the second wireless communication method.

14. An error processing method for a target terminal, the method comprising;
connecting with an initiator terminal via wireless communication with a first wireless communication method;
connecting with the initiator terminal via wireless communication with a second wireless communication method different from the first wireless communication method;
permitting the initiator terminal to access remotely to a storage medium that the target terminal includes; and
executing an access protocol process for remote access to the storage medium,
wherein if an error occurs during accessing to the storage medium from the initiator terminal, executing the access protocol process for remote access to the storage medium that is different in the wireless communication with the first wireless communication method and in the wireless communication with the second wireless communication method.
